(19) United States
(12) Patent Application Publication
(10) Pub. No.: US 2020/0206713 A1
(43) Pub. Date: Jul. 2, 2020

(54) OBJECT, DEVICE, AND PROCESSING METHOD

(71) Applicant: NEC CORPORATION, Tokyo (JP)

(72) Inventors: Hidefumi HIURA, Tokyo (JP); Jingwen LU, Tokyo (JP)

(73) Assignee: NEC CORPORATION, Tokyo (JP)

(21) Appl. No.: 16/613,640

(22) PCT Filed: Mar. 26, 2018
(86) PCT No.: PCT/JP2018/011962

§ 371 Date: Nov. 14, 2019

(30) Foreign Application Priority Data
May 18, 2017 (JP) 2017-098720
Nov. 21, 2017 (JP) 2017-223622

(51) Int. Cl. B01J 19/12; G02B 26/00; G01J 3/26

(52) U.S. Cl. CPC B01J 19/12; B01J 2219/089; G01J 3/26; G02B 26/001

(57) ABSTRACT

An object according to an example embodiment is an object containing a matter having an OH (OD) group, in which the object exists in a structure in which light having a wavelength that resonates with stretching vibration of the OH (OD) group resonates. This object is achieved by using, for example, a device including a structure in which light having a wavelength that resonates with stretching vibration of the OH (OD) group resonates and an inlet for introducing an object into the structure is used. The object is used as a solvent, for example. Specifically, the object is used in a processing method which includes placing a solvent containing a solute inside a structure in which light having a wavelength that resonates with stretching vibration of a group included in the solvent resonates and reacting the solute.

### CROSS REFERENCE TO RELATED APPLICATIONS

This application is a National Stage of International Application No. PCT/JP2018/011962 filed Mar. 26, 2018, claiming priority based on Japanese Patent Application No. 2017-098720, filed May 18, 2017 and Japanese Patent Application No. 2017-223622 filed Nov. 21, 2017 and the entire disclosures thereof are incorporated herein.

### TECHNICAL FIELD

The present invention relates to an object, a device, and a processing method.

### BACKGROUND ART

All matters (except for monoatomic molecules) have chemical bonds. Another matter is generated by breaking and formation of a chemical bond, i.e, a chemical reaction. The rate of a chemical reaction is governed by the activation energy. Generally, there are the following two methods for increasing the reaction rate. The first method is to input heat that overcomes the activation energy. The second method is to change the reaction path by using a catalyst. However, with the first method, the energy cost increases, and there is a possibility of generation of an unintended by-product. Further, the second method requires a rare metal or an expensive chemical substance as a catalyst. Moreover, since a catalyst does not exist in all chemical reactions, the second method is not versatile.

As a new method of controlling a chemical reaction, for example, Patent Document 1 discloses a method of using a coupling between an electromagnetic wave and a matter. Specifically, the method includes a process of bringing a reflective or photonic structure including an electromagnetic mode resonant with a transition in the molecule, a biomolecule, or a matter, and a process of arranging the molecule, biomolecule, or the matter inside or on the aforementioned type of structure.

### RELATED DOCUMENT

### Patent Document

[Patent Document 1] PCT Japanese Translation Patent Application Publication No. 2014-513304

### SUMMARY OF THE INVENTION

### Technical Problem

The chemical reaction often proceeds using a solvent. Many solvents include hydroxy groups (OH group and OD group, O: oxygen, H: light hydrogen, D: deuterium) such as water and alcohol. The present inventors have studied to control the reaction rate of a chemical reaction by changing the coupling state of a matter that may serve as a solvent.

An object of the present invention is to change a coupling state of a matter that may become a solvent.

### Solution to Problem

An aspect of the present invention provides an object including a matter having at least one of an OH group and an OD group, in which the object exists in a structure in which light having a wavelength that resonates with stretching vibration of the at least one group resonates.

Another aspect of the present invention provides a device including a structure in which light having a wavelength that resonates with stretching vibration of at least one of an OH group and an OD group resonates; and

an inlet for introducing an object into the structure.

Another aspect of the present invention provides a processing method including placing a solvent containing a solute inside a structure in which light having a wavelength that resonates with stretching vibration of a group included in the solvent resonates and reacting the solute.

### Advantageous Effects of Invention

According to the present invention, a coupling state of a matter that may serve as a solvent can be changed.

### BRIEF DESCRIPTION OF THE DRAWINGS

The above-described object and other objects, features, and advantages will become more apparent from the preferred example embodiments described below and the accompanying drawings.

FIGS. 1(A) and 1(B) are schematic diagrams illustrating an interaction between light and matter.

FIGS. 2(A) and 2(B) are schematic diagrams illustrating a relation between vibration of a matter and a chemical reaction.

FIGS. 3(A) and 3(B) are schematic diagrams illustrating a principle of reducing activation energy by a vibrational coupling.

FIGS. 4(A) to 4(D) are diagrams quantitatively illustrating promotion of a chemical reaction by a vibrational coupling.

FIGS. 5(A) to (C) are schematic diagrams illustrating a relation between a cavity and an optical mode.

FIGS. 6(A) and 6(B) are diagrams quantitatively illustrating a decay length and a propagating length of an optical mode.

FIGS. 7(A) and 7(B) are schematic diagrams of a vibrational coupling chemical reaction device according to an embodiment of the present invention.

FIGS. 8(A) to 8(C) are cross-sectional views of vibrational coupling chemical reaction devices according to another embodiment of the present invention.

FIGS. 9(A) to 9(F) are schematic diagrams of vibrational coupling chemical reaction device units and a system composed of the units, according to the embodiment of the present invention.

FIGS. 10(A) to 10(E) are schematic diagrams illustrating processes of a method for producing the vibrational coupling chemical reaction device according to the embodiment of the present invention.

FIGS. 11(A) to 11(G) are cross-sectional views illustrating processes of a method for producing the vibrational coupling chemical reaction device according to another embodiment of the present invention.

FIGS. 12(A) and 12(B) are diagrams illustrating infrared transmission spectra when a vibrational mode of OH stretching of light water (H₂O) and a vibrational mode of OD stretching mode of heavy water (D₂O) of various concentrations are vibrationally coupled with an optical mode of a Fabry-Pérot cavity.

FIG. 13 is a diagram illustrating a relation between a coupling strength Ω_{R}/ω₀ and a concentration of light water (H₂O) and heavy water (D₂O).

FIGS. 14(A) and 14(B) are diagrams illustrating infrared transmission spectra when a vibrational mode of OH stretching of pure light water (H₂O) and a vibrational mode of OD stretching of heavy water (D₂O) are vibrationally coupled with various optical modes of the Fabry-Pérot cavity.

FIG. 15 is a diagram illustrating a relation between a coupling strength Ω_{R}/ω₀ and an optical mode number of light water (H₂O) and heavy water (D₂O) under ultra strong coupling.

FIG. 16 is a diagram quantitatively illustrating a relation between a relative reaction rate constant and activation energy of ultra strong coupling water.

FIG. 17 is a diagram illustrating a relation between a coupling strength of a matter having an OH (OD) group and a number density of the OH (OD) group.

FIGS. 18(A) to 18(C) are diagrams illustrating promotion of a chemical reaction between water and cyanate ions by a vibrational ultra strong coupling.

FIGS. 19(A) to 19(C) are diagrams illustrating promotion of a chemical reaction between water and ammonia borane by a vibrational ultra strong coupling.

FIGS. 20(A) and 20(B) are diagrams comparing infrared transmission spectra of liquid water and solid ice to each other when a vibrational mode of OH stretching of pure light water (H₂O) and a vibrational mode of OD stretching of pure heavy water (D₂O) are vibrationally coupled with an optical mode of the Fabry-Pérot cavity.

FIG. 21 are diagrams illustrating a relation between a frequency of upper branch and lower branch polaritons and a coupling strength in water and ice.

FIG. 22 is a diagram illustrating a relation between coupling strengths of matters, including ice, having an OH (OD) group and a number density of the OH (OD) group.

FIGS. 23(A) and 23(B) are diagrams illustrating a relation between a Rabi splitting energy Ω_{R} and a concentration of water and ice of light water (H₂O).

FIGS. 24(A) and 24(B) are diagrams illustrating a relation between a Rabi splitting energy Ω_{R} and a concentration of water and ice of heavy water (D₂O).

FIG. 25 is a diagram illustrating comparing a relation between a coupling strength Ω_{R}/ω₀ and a concentration of ice of light water (H₂O) and heavy water (D₂O).

FIG. 26 is a diagram illustrating a relation between a ratio of relative reaction rate constants of ice and water and activation energy.

FIGS. 27(A) and 27(B) are schematic diagrams of a chemical reaction device when ice under a vibrational coupling is used for promoting a chemical reaction.

FIGS. 28(A) and 28(B) are diagrams comparing melting points of ultra strong coupling ice and normal ice.

### DESCRIPTION OF EMBODIMENTS

Hereinafter, an example embodiment of the present invention will be discussed with reference to drawings. In all the drawings, the same components are denoted by the same reference numerals, and the description thereof will not be repeated.

An outline of this example embodiment will be described. A processing method according to this example embodiment is a method which includes placing a solvent containing a solute inside a structure in which light having a wavelength that resonates with stretching vibration of a group included in the solvent resonates and reacting the solute. In this method, the vibrational coupling of the group that the solute has is used. The group contained in the solvent is, for example, at least one of an OH group and an OD group (hereinafter referred to as an OH (OD) group). Therefore, an object containing a matter having an OH (OD) group is caused to exist in a structure in which light having a wavelength that resonates with stretching vibration of the OH (OD) group resonates. In this processing method, for example, a device including a structure in which light having a wavelength that resonates with stretching vibration of the OH (OD) group resonates and an inlet for introducing an object into the structure is used. The solute may be of one kind or a plurality of kinds. In a case where there is one kind of solute, an example of the above-described reaction is a decomposition reaction of the solute. In a case where there are two or more kinds of solute, an example of the above-described chemical reaction is a reaction between solutes. Hereinafter, an example embodiment of the present invention will be discussed in detail with reference to drawings.

[Principle]

First, the principle of the example embodiment will be described in Items (1) to (3) discussed below:

(1) Quantifying Chemical Reaction Using Vibrational Coupling

(2) Materializing Structure Satisfying Requirement Necessary for Vibrational Coupling

(3) Process of Materializing Vibrational Coupling Chemical Reaction Device and Producing and Processing Desired Chemical Substance

[(1) Quantifying Chemical Reaction Using Vibrational Coupling]

First, with regard to Item (1), when a quantum-mechanical phenomenon being a vibrational coupling and a physicochemical phenomenon being a chemical reaction is skillfully fused, nearly every type of chemical reaction can be phenomenally promoted and promotion of a chemical reaction can be analytically and quantitatively evaluated by a vibrational coupling, each of which will be discussed according to Items (1)-A, (1)-B, and (1)-C described below:

(1)-A: interaction between light and matter,

(1)-B: a method of describing a general chemical reaction by an expression, and

(1)-C: a method of deriving an expression quantitatively describing a reaction rate constant under a vibrational coupling.

[(1)-A: Interaction Between Light and Matter]

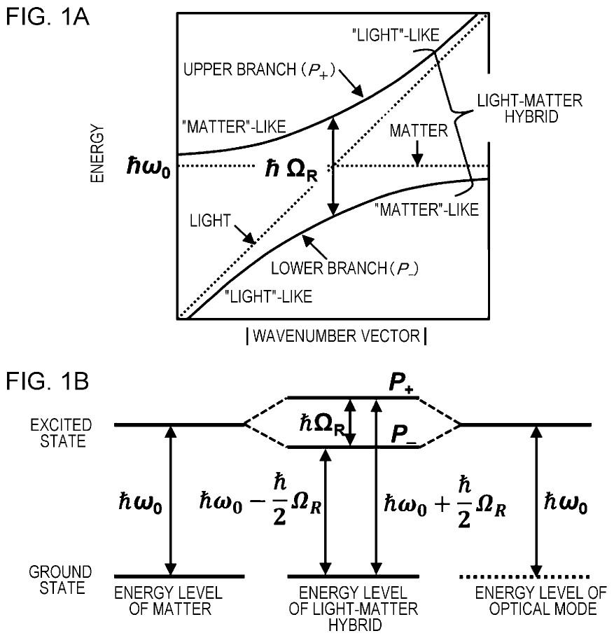

When a matter is placed in a structure in which a local optical electrical-field can exist (such as a cavity or a surface plasmon-polariton structure), light and the matter start to have a new dispersion relation with respect to energy and momentum, as illustrated in FIG. 1(A). This applies to every matter, independent of a phase such as a gas phase, a liquid phase, or a solid phase. The new dispersion constitutes curves composed of an upper branch (P₊) and a lower branch (P₋) anticrossing optical dispersion (a steadily increasing straight line) and dispersion of the matter (a horizontal straight line). In other words, when an optical electrical-field is confined in a local space with a matter, light and the matter are intermixed and move back and forth between an upper branch state and a lower branch state at a Rabi angular frequency Ω_{R}. This state is referred to as a light-matter hybrid and is a macroscopic coherent (coherent) state. As illustrated in FIG. 1(A), the light-matter hybrid is “matter-like” in a region close to the matter dispersion, “light-like” in a region close to the light dispersion, and a matter and light are exactly half at an intersection of the both types of dispersion. That is, light and a matter are mixed at any ratio according to the dispersion relation of energy and momentum. An energy difference between the upper branch state and the lower branch state is referred to as Rabi splitting energy and is expressed by the following expression. The magnitude of the Rabi splitting energy is proportional to a strength of interaction between light and matter.

[symbol]

Ω_{R}

It should be noted that

[symbol]

is the Dirac constant acquired by dividing the Planck constant h by 2π. For convenience of expression, the Rabi splitting energy may be hereinafter described as hΩ_{R}. FIG. 1(B) illustrates an energy level diagram of the aforementioned light-matter hybrid. Transition energy between a ground state and an excited state of the matter matches energy of an optical mode, that is, in a resonance state, the excited state of the matter Rabi-splits into two states with a splitting width being

[symbol]

Ω_{R}

and energy of the states being

[symbol]

ω₀−½· [symbol] Ω_{R}

and

[symbol]

ω₀+½· [symbol] Ω_{R}

According to a Jaynes-Cummings model rotating-wave-approximating the aforementioned Rabi model, Rabi splitting energy hΩ_{R} is expressed by (Expression 1).

$${ℏΩ}_{R} = 2 \sqrt{N} Ed = 2 \sqrt{N} \sqrt{\frac{ℏ {ω}_{0}}{2 {ɛ}_{0} V}} d \sqrt{{n}_{ph} + 1} \qquad ( Expression 1 )$$

where, as described above,

[symbol]

denotes the Dirac constant (acquired by dividing the Planck constant h by 2π), and Ω_{R} denotes a Rabi angular frequency, N denotes a particle number of the matter, E denotes an amplitude of the optical electrical-field, d denotes a transition dipole moment of the matter, nₚₕ denotes a number of photons, ω₀ denotes an angular frequency of a matter transition, ε₀ denotes a vacuum dielectric constant, and V denotes a mode volume. The mode volume V approximately has magnitude of a cube of a light wavelength. Important physical conclusions implied by (Expression 1) are listed as 1) to (3) below.

(1) Rabi splitting energy hΩ_{R} is proportional to the square root of the particle number of the matter N. In other words, unlike a normal physical quantity, Rabi splitting energy hΩ_{R} is dependent on the particle number and increases as the particle number increases. The dependence on the square root of the particle number is derived from interaction between light and a matter being a macroscopic coherent phenomenon.

(2) Rabi splitting energy hΩ_{R} is proportional to the intensity of the optical electrical-field and a transition dipole moment d. In other words, interaction between light and matter increases as a structure has a stronger degree of optical electrical-field confinement, and as the matter has a stronger degree of light absorption.

(3) Rabi splitting energy hΩ_{R} has a finite value even when a number of photons nₚₕ is zero. In other words, a light-matter hybrid exists even in a dark state in which light does not exist at all. The light-matter interaction is derived from being based on quantum fluctuations in a vacuum field. In other words, from a quantum-mechanical view, a photon repeats generation and annihilation in a microscopic space, and a light-matter hybrid can be generated without providing light externally.

A ratio Ω_{R}/ω₀ between Rabi splitting energy hΩ_{R} and transition energy of a matter

[symbol]

ω₀
is referred to as a coupling strength. A coupling strength Ω_{R}/ω₀ is an indicator representing a degree of how much a transition energy is Rabi-split by light-matter interaction. Further, a coupling strength Ω_{R}/ω₀ is normalized by transition energy of a matter in an original system, and therefore systems of different energy bands can be objectively compared. Roughly speaking, a case of a coupling strength Ω_{R}/ω₀ being less than 0.01 is referred to as a weak coupling (Expression 2), a case of a coupling strength being greater than or equal to 0.01 and less than 0.1 is referred to as a strong coupling (Expression 3), a case of a coupling strength being greater than or equal to 0.1 and less than 1 is referred to as an ultra strong coupling (Expression 4), and a case of a coupling strength exceeding 1 is referred to as a deep strong coupling (Expression 5). An observed value of a coupling strength reported to date is 0.73. In other words, a deep strong coupling exists only theoretically under the present conditions, and an actual system includes up to an ultra strong coupling.

$$\begin{matrix}( Weak coupling condition ) \frac{{Ω}_{R}}{{ω}_{0}} < 0.01 & ( Expression 2 ) \\ ( Strong coupling condition ) \\ 0.01 \leq \frac{{Ω}_{R}}{{ω}_{0}} < 0.1 & ( Expression 3 ) \\ ( Ultra strong coupling condition ) \\ 0.1 \leq \frac{{Ω}_{R}}{{ω}_{0}} \leq 1 & ( Expression 4 ) \\ ( Deep strong coupling condition ) \\ 1 < \frac{{Ω}_{R}}{{ω}_{0}} & ( Expression 5 )\end{matrix}$$

[(1)-B: A Method of Describing a General Chemical Reaction by an Expression]

In brief, a chemical reaction is breaking and formation of a chemical coupling. For example, a chemical reaction by which a molecule AB is broken and a molecule BC is newly generated, where A, B, and C denote atoms, is expressed by Expression 6 below.

AB+C→A+BC (Expression 6)

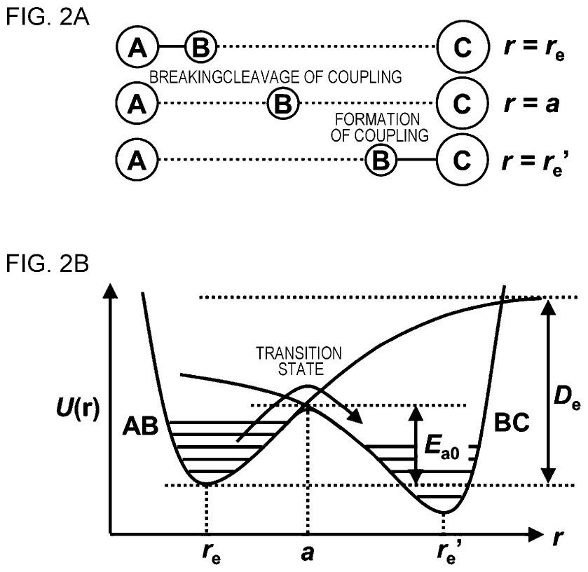

FIG. 2(A) schematically illustrates (Expression 6) as a molecular motion, and FIG. 2(B) illustrates (Expression 6) as a reaction potential being an overlap of vibration potentials U(r) of the molecule AB and the molecule BC. Describing FIGS. 2(A) and 2(B) in detail, the atom A and the atom B are bonded through a certain chemical coupling to form the molecule AB. The molecule AB performs molecular vibration with an interatomic distance r in the vicinity of an equilibrium internuclear distance rₑ. Activation energy Eₐ₀ of a forward reaction of the system is defined by (Expression 7) below as a difference between potential energy U(a) at an interatomic distance a in a transition state and potential energy U(rₑ) at the equilibrium internuclear distance rₑ, in a vibration potential of the molecule AB. When a vibration potential U(r) of the molecule AB is defined to be zero when an interatomic distance r is infinite, −U(rₑ) is equivalent to a dissociation energy Dₑ (constant) of the molecule AB. Accordingly, the following holds.

Eₐ₀=U(a)−U(rₑ)=U(a)+Dₑ (Expression 7)

When thermal energy sufficiently matching the activation energy Eₐ₀ is applied, classically, an amplitude of the molecular vibration increases, and quantum-mechanically, it jumps up the vibrational energy levels accompanying the reaction potential AB in a step-by-step manner. Consequently, the chemical coupling of the molecule AB is broken, followed by the movement to a reaction potential BC passing through a transition state located at an internuclear distance r=a, and a bond is newly generated between the atom B and the atom C. Through the series of processes, the chemical reaction in (Expression 6) is completed. Vibration energy E of a molecule is described by (Expression 8) below.

$${E}_{v} = ( v + \frac{1}{2} ) ℏ ω = ( v + \frac{1}{2} ) ℏ \sqrt{\frac{k}{m}} \qquad ( Expression 8 )$$

It should be noted that v denotes a vibrational quantum number,

[symbol]

denotes the aforementioned Dirac constant, ω denotes an angular frequency, k denotes a force constant, and m denotes a reduced mass. A force constant k is also referred to as a spring constant and is an indicator of a strength of a chemical coupling. Specifically, when a value of a force constant k is small, vibrational energy Eᵥ is small and a chemical coupling is weak. On the contrary, when a value of a force constant k is large, vibrational energy Eᵥ is large and a bond is strong. In addition, under harmonic oscillator approximation, a force constant k is a second differential coefficient at r=rₑ in a vibration potential. Accordingly, a bottom of a vibration potential U(r) becomes shallow when a value of a force constant k is small, and the bottom becomes deep when the force constant k is large.

Next, the activation energy Eₐ will be expressed as a function of a force constant k as follows: as indicated by (Expression 7), the activation energy Eₐ₀ is a function of U(a). When U(a) undergoes a Taylor expansion around rₑ, (Expression 9) below is acquired.

$$\begin{matrix}U ( a ) = U ( {r}_{e} ) + {U}^{( 1 )} ( {r}_{e} ) ( a - {r}_{e} ) + \frac{{U}^{( 2 )} ( {r}_{e} )}{2 !} {( a - {r}_{e} )}^{2} + \\ \frac{{U}^{( 3 )} ( {r}_{e} )}{3 !} {( a - {r}_{e} )}^{3} + … \\ = - {D}_{e} + \frac{1}{2} {k ( a - {r}_{e} )}^{2} + \frac{{U}^{( 3 )} ( {r}_{e} )}{3 !} {( a - {r}_{e} )}^{3} + …\end{matrix} \qquad ( Expression 9 )$$

where U⁽ⁿ⁾(r) denotes an n-th derivative of U(r). It should be noted that in modification of (Expression 9), the following conditions are used. First, −U(rₑ) is equivalent to dissociation energy Dₑ, as described above, and therefore U(rₑ)=−Dₑ. Next, the first derivative of a vibration potential is force and a value thereof is zero at the equilibrium internuclear distance rₑ and therefore U⁽¹⁾(rₑ)=0. Next, the second derivative of the vibration potential at the equilibrium internuclear distance rₑ is the force constant k, as described above. Combining (Expression 7) with (Expression 9) and neglecting the third and subsequent terms by harmonic oscillator approximation yields (Expression 10) below.

Eₐ₀=½(a−rₑ)² (Expression 10)

In general, a force constant k is determined by an electronic state of a molecule and therefore is a constant inherent to the molecule and cannot be changed once an elementary composition and a structure are determined. Further, once an electronic state is determined, both an interatomic distance a in a transition state and an equilibrium internuclear distance rₑ are also constant. Accordingly, the activation energy Eₐ cannot be changed unless a reaction potential or a vibration potential being a component thereof is changed. However, as will be discussed in the next item, the force constant may be decreased by using a vibrational coupling being a kind of interaction between light and matter. Thus, the activation energy Eₐ can be reduced according to the relation in (Expression 10).

[(1)-C: Method of Deriving Expression Quantitatively Describing Reaction Rate Constant Under Vibrational Coupling]

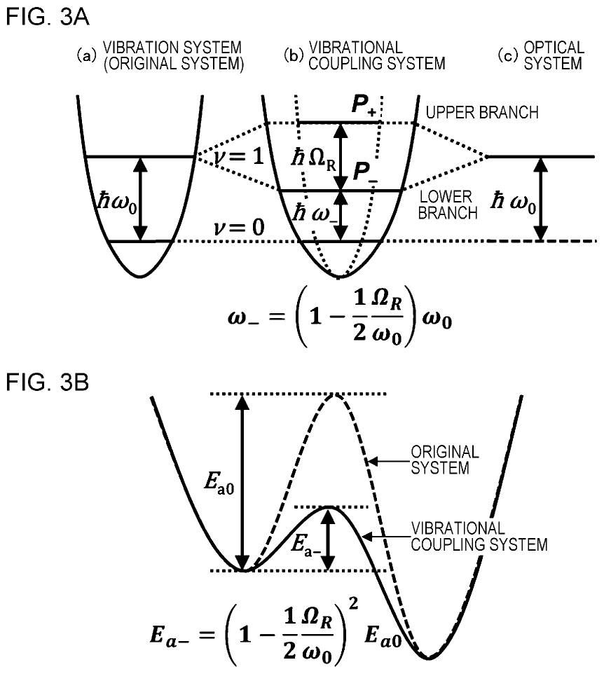

A vibrational coupling is a kind of the aforementioned interaction between light and matter and refers to a phenomenon of an optical mode formed by a cavity capable of confining an electromagnetic wave in an infrared region (wavelength: 1 to 100 μm) or a surface plasmon-polariton structure being coupled with a vibrational mode of a chemical substance such as a molecule or a crystal. In FIG. 3(A), (a) illustrates an energy level (a harmonic oscillator approximation) of a vibration system (original system), (b) illustrates an energy level (harmonic oscillator approximation) of a vibrational coupling system, and (c) illustrates an energy level of an optical system. Vibration energy of the vibration system (a) and energy of the optical system (c) match at

[symbol]

ω₀

In other words, when the vibration system (a) resonates with the optical system (c) at an angular frequency ω₀, a vibrational coupling system (b) in which light (the optical system) and matter (the vibration system) are mixed is generated. In the vibrational coupling system (b), a vibrational level v=0 is equivalent to that in the vibration system being an original system; however, a vibrational level v=1 splits into energy levels being an upper branch and a lower branch.

Next, vibrational energy of the vibrational coupling system will be determined. By use of vibrational energy of the vibration system being an original system

[symbol]

ω₀

and Rabi splitting energy hΩ_{R}, vibrational energy w₋ of the lower branch of the vibrational coupling system is expressed by (Expression 11) below.

$${ℏω}_{-} = ( 1 - \frac{1}{2} \frac{{Ω}_{R}}{{ω}_{0}} ) {ℏω}_{0} \qquad ( Expression 11 )$$

Vibrational energy ω₊ of the upper branch can be expressed as ω₊=(1+½·Ω_{R}/ω₀), however, as will be discussed later, a vibrational level of the upper branch of the vibrational coupling system does not contribute to promotion of a chemical reaction and therefore is not hereinafter mentioned. As indicated by (Expression 11), the vibrational energy ω₋ of the vibrational coupling system decreases from the vibrational energy of the original system

[symbol]

ω₀

by ½·Ω_{R}/ω₀. As indicated in (b) in FIG. 3(A), the above corresponds to a bottom of the vibration potential of the vibrational coupling system being shallower than that of the original system. Recollecting that the second derivative of the very bottom of the vibration potential is a force constant, it is understood that a force constant k₋ of the vibrational coupling system is smaller than a force constant k₀ of the original system. The above can be quantitatively expressed as (Expression 12) below by use of (Expression 8) and (Expression 11).

$${k}_{-} = {( 1 - \frac{1}{2} \frac{{Ω}_{R}}{{ω}_{0}} )}^{2} {k}_{0} \qquad ( Expression 12 )$$

Next, activation energy of the vibrational coupling system will be determined. When activation energy of the original system is denoted as Eₐ₀, activation energy of the strong vibrational coupling system is denoted as Eₐ₋, (Expression 13) below is acquired from (Expression 10) and (Expression 12).

$${E}_{a -} = {( 1 - \frac{1}{2} \frac{{Ω}_{R}}{{ω}_{0}} )}^{2} {E}_{a 0} \qquad ( Expression 13 )$$

It should be noted that, in (Expression 13), we used an approximation that a difference between an equilibrium internuclear distance and an interatomic distance in the transition state is nearly the same between the original system and the vibrational coupling system. Referring to FIG. 3(B), (Expression 13) clearly states that activation energy is reduced in the vibrational coupling system compared with the original system. For example, activation energy decreases by approximately 1 to 10% in the strong coupling condition expressed by (Expression 3) and by approximately 10 to 75% in the ultra strong coupling condition expressed by (Expression 4). In other words, it is anticipated that significant promotion of a chemical reaction can be acquired by use of a vibrational strong coupling or further a vibrational ultra strong coupling.

As a supplement to this section. The reason for existence of the upper branch of the vibrational coupling system being neglected in the discussion will be discussed. Referring to (Expression 13), activation energy Eₐ₊ corresponding to vibrational energy of the upper branch becomes

$${E}_{a +} = {( 1 + \frac{1}{2} \frac{{Ω}_{R}}{{ω}_{0}} )}^{2} {E}_{a 0}$$

The activation energy Eₐ₊ of the upper branch is greater than the activation energy Eₐ₀ of the original system, and therefore remaining at the upper branch level slows a reaction compared with the original system. However, a vibrational state of a reactant molecule actually transitions back and forth between the upper branch and the lower branch Ω_{R} times per second (typically 10⁶ to 10⁷ times) in the vibrational coupling system, which is sufficiently faster than a typical reaction rate. In other words, even though the vibrational state hangs around the upper branch level with relatively high activation energy at a certain moment and thereby a reaction is not likely to occur, when the vibration state transitions to the lower branch with relatively low activation energy at the next moment, a reaction is likely to occur. Accordingly, it is concluded that existence of the upper branch can be neglected in considering a chemical reaction in the vibrational coupling system.

Next, a chemical reaction promoting action by a vibrational coupling will be quantitatively evaluated by use of a ratio of between a reaction rate constant of the vibrational coupling system and a reaction rate constant of the original system, that is, a relative reaction rate constant. A reaction rate constant is a physical quantity easier to measure compared with activation energy and is also highly practical. Further, as will be discussed later, an expression by a relative reaction rate constant provides various implications in using a vibrational coupling in chemical reaction promotion.

Assuming that, for example, the reaction indicated in (Expression 6) is a first-order reaction with respect to the molecule AB and the atom C, respectively, a reaction rate formula of a chemical reaction can be described by (Expression 14) below.

R=κ[AB][C] (Expression 14)

where R denotes a reaction rate, κ (kappa) denotes a reaction rate constant, [AB] and [C] denote concentrations of the molecule AB and the atom C, respectively. The reaction rate is defined as a change in a concentration per unit time and has a dimension of concentration/time. The unit of the reaction rate constant varies by an order of reaction, and when second (s) is taken as the unit of time and molarity M (M: molar concentration where M=mol·L⁻¹, L: liter) is taken as the unit of a concentration, for example, the unit of a zero-order reaction is M·s⁻¹ having the same dimension as a reaction rate, the unit of a first-order reaction is s⁻¹, and the unit of a second-order reaction is M⁻¹·s⁻¹. A reaction rate constant is expressed by (Expression 15) below as a function of a frequency factor A, activation energy Eₐ₀, and temperature T.

$$κ = A exp ( - \frac{{E}_{a 0}}{{k}_{B} T} ) \qquad ( Expression 15 )$$

where k_{B} denotes the Boltzmann constant. (Expression 15) is an empirical formula known as the Arrhenius equation. On the other hand, (Expression 16) below is the Eyring equation being one of theoretical formulae deduced from the transition state theory.

$$κ = ( \frac{a}{{r}_{e}} ) \frac{ω}{2 π} exp ( - \frac{{E}_{a 0}}{{k}_{B} T} ) \qquad ( Expression 16 )$$

While the Eyring equation has various expressions, an expression used in a most basic chemical reaction (a dissociation reaction) is used here. It should be noted that a denotes an interatomic distance in the aforementioned transition state, and similarly, rₑ denotes the aforementioned equilibrium internuclear distance. Next, a ratio between a reaction rate constant in the presence of a vibrational coupling and a reaction rate constant in the absence of a vibrational coupling, that is, a relative reaction rate constant, will be determined. First, by substituting (Expression 13) indicating activation energy of the vibrational coupling system determined in the previous section into (Expression 15) and (Expression 16), respectively, expressions representing a reaction rate constant in the presence of a vibrational coupling are derived, respectively. Next, by determining ratios of these expressions to the original system, that is, the expressions ((Expression 15) and (Expression 16)) indicating the reaction rate constant in the absence of vibrational coupling, (Expression 17) and (Expression 18) below, which are expressions of a relative reaction rate constant, are finally acquired, respectively.

$$\begin{matrix}( Arrhenius \text{-} type ) \frac{{κ}_{-}}{{κ}_{0}} = exp [ ( - \frac{{E}_{a 0}}{{k}_{B} T} ) \{ {( 1 - \frac{1}{2} \frac{{Ω}_{R}}{{ω}_{0}} )}^{2} - 1 \} ] & ( Expression 17 ) \\ ( Eyring \text{-} type ) \frac{{κ}_{-}}{{κ}_{0}} = ( 1 - \frac{1}{2} \frac{{Ω}_{R}}{{ω}_{0}} ) exp [ ( - \frac{{E}_{a 0}}{{k}_{B} T} ) \{ {( 1 - \frac{1}{2} \frac{{Ω}_{R}}{{ω}_{0}} )}^{2} - 1 \} ] & ( Expression 18 )\end{matrix}$$

However, in derivation of (Expression 17), because a vibrational coupling does not affect a collision frequency of molecules, it is assumed that a frequency factor A takes an identical value between the case in the presence of a vibrational coupling and the case in the absence of a vibrational coupling. According to this assumption, the term of the frequency factor A disappears in (Expression 17). Further, in derivation of (Expression 18), it is approximated that a ratio between an interatomic distance a in a transition state and an equilibrium internuclear distance rₑ is nearly identical between the case in the presence of a vibrational coupling and the case in the absence of a vibrational coupling. By this approximation, the term of ((a/rₑ) in (Expression 18) is canceled. It is worthy to note that (Expression 17) and (Expression 18) are expressions derived before anyone else in the world as a result of concentrated examinations by the present inventors.

By the theoretical considerations discussed above, we are not only freed from various physical quantities, such as a frequency factor A, an interatomic distance a in a transition state, and an equilibrium internuclear distance rₑ, all of which are difficult to be experimentally measured or difficult to be theoretically estimated, but also can acquire a simple and clear expression expressing a relative reaction rate constant (a ratio κ₋/κ₀ between a reaction rate constant of an original system and a reaction rate constant of a vibrational coupling system) with merely three physical quantities as parameters, that is, activation energy Eₐ₀ and temperature T being experimentally and theoretically familiar physical quantities, and a coupling strength Ω_{R}/ω₀ being the most important indicator of a vibrational coupling. By derivation of (Expression 17) and (Expression 18), an effect of a vibrational coupling on a chemical reaction can be quantitatively evaluated. In other words, by use of (Expression 17) and (Expression 18), for example, when a vibrational coupling is applied to a chemical reaction, it is possible to previously predict a degree of reaction promotion expected in the target chemical reaction, an effect of temperature, effectiveness of magnitude of activation energy, a type of chemical reaction advantageous to a vibrational coupling, and the like as objective numerical values.

A further advantage of (Expression 17) and (Expression 18) is that the expressions are applicable regardless of a type of chemical reaction. For example, (Expression 17) and (Expression 18) hold regardless of a phase, such as a gas phase, a liquid phase, or a solid phase, in which a chemical reaction occurs. The reason is that (Expression 17) and (Expression 18) do not include a parameter limiting a phase. Further, as to an order of reaction of a chemical reaction, reaction promotion by a vibrational coupling can be accurately evaluated by use of (Expression 17) and (Expression 18) with respect to a chemical reaction with any order including a first-order reaction, a second-order reaction, a third-order reaction, and any other reaction with a complicated order such as a 1.5-th reaction. The versatility is derived from employment of a relative reaction rate constant κ₋/κ₀ being a ratio between reaction rate constants of an original system and a vibrational coupling system in the expressions in (Expression 17) and (Expression 18); and since κ₋/κ₀ is an abstract number, any reaction can be quantitatively analyzed regardless of a unit. From the above, it can be concluded that (Expression 17) and (Expression 18) are an exceptionally powerful weapon in designing a chemical reaction device using a vibrational coupling.

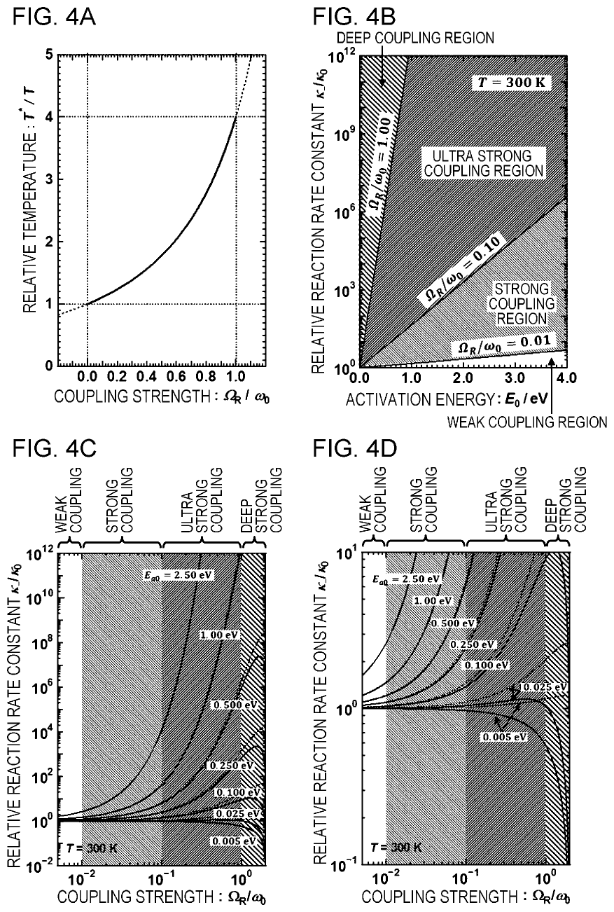

Referring to FIGS. 4(A) to 4(D), many findings are obtained from (Expression 17) and (Expression 18) in quantitative understanding of promotion of a chemical reaction by a vibrational coupling. As a first example, a way how to convert a coupling strength Ω_{R}/ω₀ to reaction temperature will be discussed. When a reaction rate constant at a certain temperature T is denoted as κ₀ and a reaction rate constant at another temperature T* is denoted as κ* in a certain chemical reaction, a ratio between κ₀ and κ* is described by (Expression 19) below by referring to the Arrhenius equation in (Expression 15).

$$\frac{{κ}^{*}}{{κ}_{0}} = exp [ ( - \frac{{E}_{a 0}}{{k}_{B} T} ) ( \frac{T}{{T}^{*}} - 1 ) ] \qquad ( Expression 19 )$$

Assuming that an effect of vibrational coupling on a reaction rate constant is the same as an effect of temperature, that is, κ₋=κ*, since (Expression 17) and (Expression 19) are exponential functions of the same type, (Expression 20) below is acquired by comparing exponent parts.

$$\frac{{T}^{*}}{{T}_{0}} = {( 1 - \frac{1}{2} \frac{{Ω}_{R}}{{ω}_{0}} )}^{- 2} \qquad ( Expression 20 )$$

(Expression 20) is an expression indicating how to convert a coupling strength Ω_{R}/ω₀ to reaction temperature. (Expression 20) implies that an effect of a vibrational coupling with a certain coupling strength Ω_{R}/ω₀ is equivalent to an effect of how many times of reaction temperature.

FIG. 4(A) is a diagram illustrating the conversion of a coupling strength Ω_{R}/ω₀ to reaction temperature discussed in (Expression 20). For example, T*=332.4K is acquired when Ω_{R}/ω₀=0.1 and T=300.0K. In other words, a vibrational coupling with a coupling strength 0.1 is equivalent to raising a system temperature from room temperature by 32K. In a similar conversion way, vibrational couplings with respective coupling strength of 0.3 and 0.5 are equivalent to raising the system temperature from room temperature by 142.1K and 260.2K, respectively. Furthermore, T*=1200K is obtained when Ω_{R}/ω₀=1.0 and T=300.0K, This means that a vibrational coupling with a coupling strength of 1.0 can cause a chemical reaction normally requiring a reaction temperature as high as 1200 K to progress at room temperature (300K) with the same reaction rate. This is an example of a remarkable effect of a vibrational coupling on a chemical reaction clearly stated by (Expression 20) derived from (Expression 17). Further, (Expression 17) is useful in visualizing, with quantitative accuracy, an effect of a vibrational coupling on a chemical reaction as shown next.

Referring to FIG. 4(B), the figure is a diagram visualizing a region occupied by each condition for a weak coupling, a strong coupling, an ultra strong coupling, and a deep strong coupling expressed by (Expression 2) to (Expression 5) and a performance of promotion of a chemical reaction provided in each region, on a two-dimensional map with respect to a relative reaction rate constant κ₋/κ₀ and activation energy Eₐ₀ when a chemical reaction proceeds at room temperature (T=300K). A boundary between the respective regions in FIG. 4(B) is a straight line satisfying respective conditions of Ω_{R}/ω₀=0.01, 0.10, and 1.00. While it is difficult for a relative reaction rate constant κ₋/κ₀ to exceed 10 under the vibrational weak coupling region, the relative reaction rate constant κ₋/κ₀ becomes 10 or greater when Eₐ₀=1.0 eV and 10² or greater when Eₐ₀=2.0 eV around the middle of the vibrational strong coupling region. The relative reaction rate constant: κ₋/κ₀ becomes 10³ or greater when Eₐ₀=1.0 eV, and 10⁶ or greater when Eₐ₀=2.0 eV around the middle of the vibrational ultra strong coupling region, and when entering the vibrational deep strong coupling to region, the relative reaction rate constant: κ₋/κ₀ becomes 10¹² or greater when Eₐ₀≥1.0 eV. Namely, while a remarkable effect on promotion of a chemical reaction is not likely to be obtained with a vibrational weak coupling, a remarkable effect is likely to be acquired with a vibrational strong coupling, a vibrational ultra strong coupling, and a vibrational deep strong coupling. In addition, the effect increases exponentially in ascending order of a vibrational strong coupling, a vibrational ultra strong coupling, and a vibrational deep strong coupling. However, as discussed above, since a deep strong coupling has not yet been discovered in an actual system, it is substantially essential to realize a vibrational strong coupling and a vibrational ultra strong coupling when promoting a chemical reaction by several orders of magnitude.

FIG. 4(C) is a graph depicting activation energy dependence of a relative reaction rate constant curve illustrated on a two-dimensional map with respect to a relative reaction rate constant κ₋/κ₀ and a coupling strength Ω_{R}/ω₀ and superimposing thereon the weak coupling, strong coupling, ultra strong coupling, and deep strong coupling regions at the same time. A solid line represents an Eyring-type relative reaction rate constant κ₋/κ₀ curve based on (Expression 18), and a dotted line represents an Arrhenius-type relative reaction rate constant κ₋/κ₀ curve based on (Expression 17). FIG. 4(D) is a diagram enlarging FIG. 4(C) in a vertical axis direction.

The first characteristic of FIG. 4(C) and FIG. 4(D) is that a relative reaction rate constant κ₋/κ₀ exponentially increases as a coupling strength Ω_{R}/ω₀ increases. The tendency toward exponential increase in a relative reaction rate constant κ₋/κ₀ becomes more remarkable as an amount of activation energy Eₐ₀ increases.

The second characteristic of FIG. 4(C) and FIG. 4(D) is that a relative reaction rate constant κ₋/κ₀ does not reach 3 even when Eₐ₀=2.50 eV where the increasing tendency is largest in the weak coupling region. On the other hand, a relative reaction rate constant κ₋/κ₀ reaches a maximum of 10⁴ in the strong coupling region. Furthermore, in the ultra strong coupling region, a relative reaction rate constant reaches κ₋/κ₀=10¹² at Eₐ₀=2.50 eV even when Ω_{R}/ω₀=0.3 and reaches κ₋/κ₀≈10³ at Eₐ₀=0.250 eV, κ₋/κ₀≈10⁶ at Eₐ₀=0.500 eV, and κ₋/κ₀≈10¹² at Eₐ₀=1.00 eV when Ω_{R}/ω₀=1.0.

The third characteristic of FIG. 4(C) and FIG. 4(D) is that a discrepancy is generated between an Arrhenius-type curve (a dotted line) based on (Expression 17) and an Eyring-type curve (a solid line) based on (Expression 18), as a coupling strength Ω_{R}/ω₀ increases. In particular, in the deep strong coupling region, a discrepancy between both curves increases as activation energy Eₐ₀ decreases, and finally, when activation energy Eₐ₀ becomes less than 0.025 eV, a relative reaction rate constant κ₋/κ₀ falls below one. The reason for this phenomenon is that, one hand, a relative reaction rate constant κ₋/κ₀ monotonically increases as a coupling strength Ω_{R}/ω₀ increases due to absence of a pre-exponent term (a term added in front of an exponential function) in (Expression 17) being Arrhenius-type, on the other hand, a pre-exponent term (1−½·Ω_{R}/ω₀) suppresses increase of a relative reaction rate constant κ₋/κ₀ in (Expression 18) being Eyring-type. However, considering that a deep strong coupling has not been realized and therefore does not need to be considered under the present conditions, and a discrepancy between (Expression 17) and (Expression 18) is relatively small and therefore the two draw nearly identical curves in the weak coupling, strong coupling, and ultra strong coupling regions, whether to use (Expression 17) or (Expression 18) makes no big difference in evaluation of promotion of a chemical reaction by a vibrational coupling.

[(2) Process of Materializing Structure Satisfying Requirement Necessary for Vibrational Coupling]

Next, with regard to Item (2), a process of materializing a structure satisfying a requirement necessary for a vibrational coupling will be discussed based on Item (1), according to Items (2)-A, (2)-B, and (2)-C described below. Specific productions of the structure will be discussed later in the [Description of Production Method section].

(2)-A: an optical electrical-field confinement structure for forming an optical mode and a requirement of the structure

(2)-B: a vibrational mode possessed by a chemical substance used in a chemical reaction and a requirement of the vibrational mode

(2)-C: a vibrational coupling between an optical mode and a vibrational mode, and a requirement of the vibrational coupling

[(2)-A: Optical Electrical-Field Confinement Structure for Forming Optical Mode and Requirement of Structure]

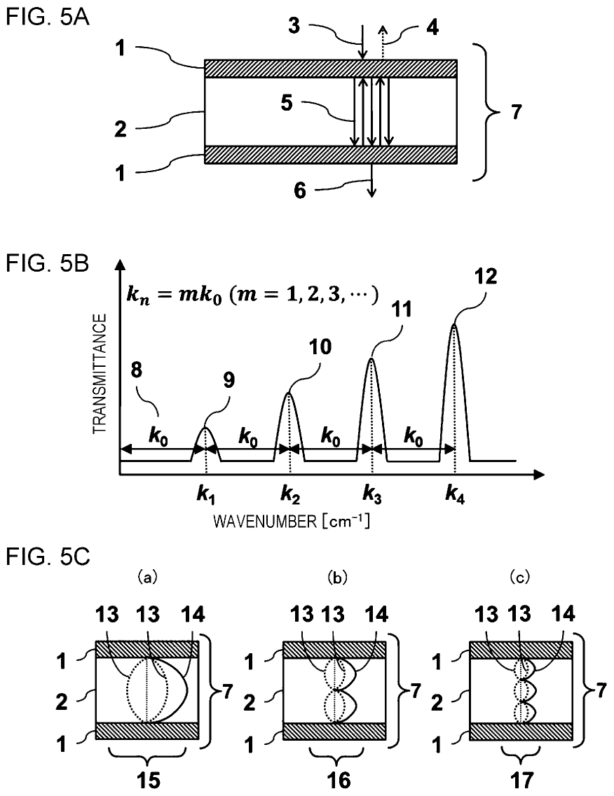

An optical electrical-field confinement structure for forming an optical mode and a requirement of the structure will be discussed. The first structure to be listed as a structure capable of confining an optical electrical-field is a Fabry-Pérot cavity. As illustrated in FIG. 5(A), a Fabry-Pérot cavity 7 is a most basic cavity configured with a set of two mirror planes 1 (including half mirrors) parallel to one another. When incident light 3 enters the Fabry-Pérot cavity 7, part of the light is reflected as reflected light 4, whereas light at a specific wavelength becomes resonant light 5 repeatedly reflected inside the Fabry-Pérot cavity 7, and part of the resonant light 5 is transmitted as transmitted light 6. This image is expressed by a mathematical expression as follows. That is, assuming a cavity length being a distance between two mirror planes is taken as t [μm], when a dielectric 2 with a refractive index n is sandwiched between the mirror planes 1, an optical mode expressed by a relation in (Expression 21) below develops between the two mirror planes 1.

$${k}_{m} = {mk}_{0} = m \frac{{10}^{4}}{2 n t} ( m = 1 , 2 , 3 , … ) \qquad ( Expression 21 )$$

where kₘ denotes a wavenumber (unit: cm⁻¹) of the optical mode, and m denotes an optical mode number and is a natural number. For example, when a cavity length t is nearly equal to an infrared wavelength, that is, t=about 1 to 100 μm, an optical mode of the Fabry-Pérot cavity 7 can be measured by a Fourier transform infrared spectrophotometer (FT-IR) or the like. FIG. 5(B) is a schematic diagram of a transmitted spectrum of an optical mode conforming to (Expression 21). While the first optical mode 9, the second optical mode 10, the third optical mode 11, the fourth optical mode 12, and the like appear at equal optical mode intervals 8 (k₀) from a lower wavenumber to a higher wavenumber, infrared light is not transmitted between optical modes. The reason is that only infrared light having a node on an end face of the mirror plane 1 generates resonance between the mirror planes 1 and the infrared light gains a strength to be transmitted but other infrared light is immediately attenuated. In other words, the Fabry-Pérot cavity 7 transmits light at a specific wavelength while causing resonance, the cavity works as a bandpass filter intercepting light at a wavelength other than the specific wavelength. For example, in FIG. 5(C), (a) illustrates a case corresponding to the first optical mode 15 where a half wavelength of a specific wavelength is t μm, that is, the specific wavelength is 2t μm. Further, (b) corresponds to the second optical mode 16 where a half wavelength of a specific wavelength is t/2 μm, that is, the specific wavelength is t μm. Furthermore, (c) corresponds to the third optical mode 17 where a half wavelength of a specific wavelength is t/3 μm, that is, the specific wavelength is 2t/3 μm. Each has distributions of an amplitude of optical electrical-field 13 and a strength of optical electrical-field 14.

In the m-th optical mode, a ratio between a half-value width Δkₘ and a wavenumber of the optical mode kₘ is referred to as a quality factor (Q factor) and is defined by (Expression 22) below.

$${Q}_{m} = \frac{{k}_{m}}{Δ {k}_{m}} ( m = 1 , 2 , 3 , … ) \qquad ( Expression 22 )$$

A Q factor is one of performance indices of an optical electrical-field confinement structure and the reciprocal thereof is proportional to a decay of the m-th optical mode. Accordingly, as a Q factor increases, a confinement time of an optical electrical-field becomes longer, and performance as a cavity becomes better. Further, since a Q factor and a coupling strength Ω_{R}/ω₀ are in a proportional relation, referring to (Expression 17) or (Expression 18), as a Q factor takes a larger value, a relative reaction rate constant κ₋/κ₀ increases. However, based on experimental results, a Q factor with magnitude of at most 20 can provide a practical effect on promotion of a chemical reaction by a vibrational coupling. A mode volume can be cited as another performance index of a cavity. As indicated in (Expression 1), Rabi splitting energy hΩ_{R} is inversely proportional to the square root of a mode volume V. Accordingly, in order to increase a coupling strength Ω_{R}/ω₀ for a purpose of increasing a relative reaction rate constant κ₋/κ₀, the smaller the mode volume V, the more favorable. However, while the mode volume V depends on a cavity length t defining a wavenumber of an optical mode kₘ with regard to the Fabry-Pérot cavity 7, the wavenumber of an optical mode kₘ needs to match a wavenumber of the vibrational mode with regard to a vibrational coupling. As such, when the Fabry-Pérot cavity 7 is used for a vibrational coupling, a mode volume V is naturally determined to be a certain value and therefore is handled as an invariant instead of an adjustable variable.

A surface plasmon-polariton structure can be cited as another structure capable of confining an optical electrical-field. In general, a surface plasmon-polariton structure refers to a structure on which many materials, typically metal, with a dielectric function the real part of which is negative and has a large absolute value, and the imaginary part of which has a small absolute value, are cyclically arranged on a dielectric surface as a microstructure with a size and a pitch both around a wavelength of target light. When the metal microstructure is used for vibrational coupling, a size and a pitch of the structure is around a wavelength of infrared light, that is, about 1 to 100 μm.

In both the Fabry-Pérot cavity and the surface plasmon-polariton structure, the cavity length is a length at which light having a wavelength that resonates with stretching vibration of a group (for example, OH (OD) group) included in a matter that causes vibrational coupling resonates.

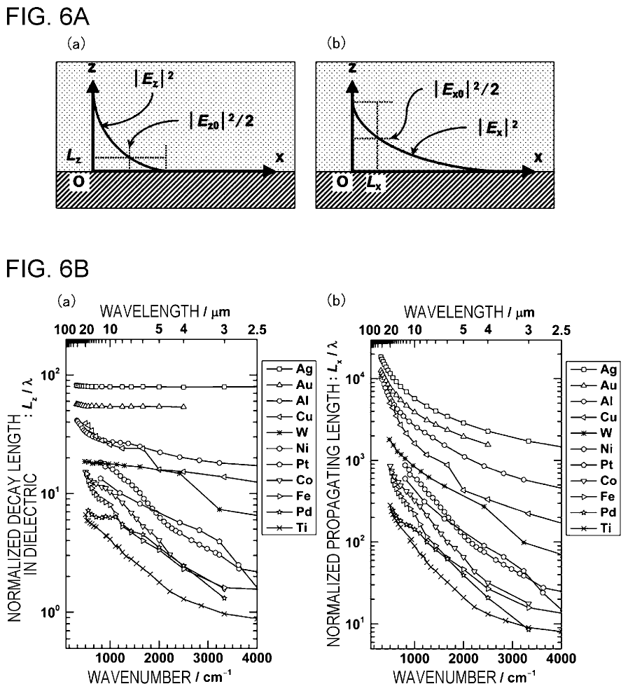

Next, propagation and decay of an optical mode will be discussed. An interface between a dielectric (a dotted part) and metal (a shaded part) is considered as illustrated in FIG. 6(A), and the origin O is taken on the interface, the z-axis is taken in a direction perpendicular to the interface, and the x-axis is taken in a direction parallel to the interface. As illustrated in (a), a distance L_{z} from the origin in the z-axis direction on the dielectric side at which a strength|E_{z}|² of an electric field E_{z} in the z-axis direction becomes half is referred to as a decay length (in the dielectric) of an optical mode. Further, as illustrated in (b), a distance Lₓ from the origin where a strength |Eₓ|² of an electric field Eₓ in the x-axis direction becomes half is referred to as a propagating length of an optical mode. By use of a dielectric constant of the dielectric ε_{D}, and a dielectric constant of the metal ε_{M}, the decay length L_{z} and the propagating length Lₓ are expressed by (Expression 23) and (Expression 24) below, respectively.

$$\begin{matrix}{L}_{Z} = \frac{λ}{4 π} \frac{1}{Im ( \frac{{ɛ}_{D}}{\sqrt{{ɛ}_{M} + {ɛ}_{D}}} )} & ( Expression 23 ) \\ {L}_{X} = \frac{λ}{4 π} \frac{1}{Im ( \sqrt{\frac{{ɛ}_{M} {ɛ}_{D}}{\sqrt{{ɛ}_{M} + {ɛ}_{D}}}} )} & ( Expression 24 )\end{matrix}$$

where λ denotes a wavelength (λ=2πc/ω, where c: speed of light) and Im(C) denotes an operator for taking the imaginary part of a complex number C. In general, a dielectric constant of a matter is a complex dielectric function including an imaginary part and a real part, and the complex dielectric function is wavelength-dependent. Accordingly, the decay length L_{z} and the propagating length Lₓ have wavelength dependence. Referring to FIG. 5(B), (a) illustrates wavenumber (wavelength) dependence of the decay length L_{z} calculated based on (Expression 23), and (b) illustrates a wavenumber (wavelength) dependence of the propagating length Lₓ calculated based on (Expression 24). The calculations have been performed for typical metals being silver (Ag), gold (Au), aluminum (Al), copper (Cu), tungsten (W), nickel (Ni), platinum (Pt), cobalt (Co), iron (Fe), palladium (Pd), and titanium (Ti), using experimental values of the complex dielectric function in an infrared region, and also under a condition that only the real part of the dielectric function of the dielectric is taken and, for the sake of simplicity, ε_{D}=1. It should be noted that, in each diagram, the vertical axis is normalized by a wavelength λ (L_{z}/λ and Lₓ/λ). Accordingly, a value on the vertical axis at a certain wavelength λ in FIG. 6(B) indicates a multiplication factor with respect to the wavelength λ.

First, taking a close look at wavenumber (wavelength) dependence of the decay length L_{z} in (a) illustrated in FIG. 6(B), several characteristics can be listed as follows:

The first characteristic is that a decay length L_{z} is generally around half of a wavelength in a visible region whereas magnitude of a decay length L_{z} changes from around a wavelength to several tens of times the wavelength in the infrared region. A decay length L_{z} indicates a range in which an optical mode can exist in a vertical direction and therefore can be considered as a range affected by a vibrational coupling. Thus, it is desirable that a decay length L_{z} be as long as possible for promotion of a chemical reaction by a vibrational coupling. A decay length L_{z} being 10 times a wavelength or longer in an entire wavenumber range of 400 to 4000 cm⁻¹ (wavelength: 25 to 2.5 μm) is observed for silver, gold, aluminum, and copper, and in the cases of silver and gold in particular, the decay length L_{z} becomes approximately 80 times and approximately 55 times the wavelength, respectively. Specifically, in the case of silver, an existence region of an optical mode extends up to approximately 0.8 mm from the interface between the metal and the dielectric in the vertical (z-axis) direction at a wavenumber: 1000 cm⁻¹ (wavelength: 10 μm). Under the same condition, an existence region of the optical mode in the vertical direction is approximately 0.5 mm for gold, approximately 0.25 mm for aluminum and copper, approximately 0.2 mm for tungsten and nickel, and approximately 0.1 mm for platinum and cobalt. In other words, for many of the metals, an effect of a vibrational coupling extends from the interface to the submillimeter order in the vertical direction. A catalyst cannot exert a catalytic action unless a reactant source material is physically or chemically bonded with an active center of the catalyst or an interface, that is, unless the catalyst and the reactant source material get close to one another down to the subnanometer order, regardless of whether the catalyst is a homogeneous catalyst or a heterogeneous catalyst. On the other hand, according to a reaction promotion mechanism by a vibrational coupling presented by the example embodiment, once a reactant source material enters a range of the submillimeter order from the interface, the reactant source material can enjoy a reaction promoting action, that is, a catalytic action. In other words, the reaction promotion mechanism by a vibrational coupling presented by the example embodiment can be considered as a catalyst with a totally new concept.

The second characteristic is that a decay length L_{z} varies by a type of metal. For example, silver with a maximum decay length L_{z} and titanium with a minimum differ by a single- or double-digit.

The third characteristic is that, for silver, gold, aluminum, copper, and tungsten, a decay length L_{z} variation by a wavenumber (wavelength) is twice at most, which is relatively small. In the cases of silver and gold in particular, a decay length L_{z} hardly has wavenumber (wavelength) dependence and takes a constant value. On the other hand, for nickel, platinum, cobalt, iron, palladium, and titanium, a decay length L_{z} variation by a wavenumber (wavelength) is around a single digit, which is relatively larger.

As the metals suited to the purpose of chemical reaction promotion by a vibrational coupling, based on the aforementioned three characteristics related to wavenumber (wavelength) dependence of the decay length L_{z}, silver and gold are most excellent, then aluminum, copper, tungsten are desirable, and nickel, platinum, cobalt, iron, palladium, and titanium are fair. Another material may be used as long as the real part of a dielectric function of the material is negative and has a large absolute value, and the imaginary part of the dielectric function has a small absolute value. Single-element metal, an alloy, metallic oxide, graphene, graphite, or the like are also applicable.

Next, referring to (b) illustrated in FIG. 6(B), wavenumber (wavelength) dependence of a propagating length Lₓ has several characteristics as follows:

The first characteristic is that in the visible region, a propagating length Lₓ is at most 10 times a wavelength (several micrometers) whereas a propagating length Lₓ increases by 10 to 10⁴ times in the infrared region. Specifically, in the case of silver, an optical mode can maintain coherence in a very wide range that is approximately 60 mm square in a horizontal direction at a wavenumber: 1000 cm⁻¹ (wavelength: 10 μm). Under the same condition, an expansion of coherence is approximately 40 mm square for gold, approximately 25 mm square for aluminum, approximately 15 mm square for copper, approximately 8.5 mm square for tungsten, approximately 7 mm square for nickel, approximately 4.5 mm square for platinum, approximately 3 mm square for cobalt, approximately 2.5 mm square for iron, approximately 1.5 mm square for palladium, and approximately 1 mm square for titanium. It should be noted that a propagating length Lₓ can be considered as an expansion in a horizontal direction in which an optical mode can maintain coherence. Therefore, a literal macroscopic coherent state literally having an expansion of the order of millimeters to centimeters can be realized. On the other hand, as indicated in (Expression 1), Rabi splitting energy hΩ_{R} is proportional to the square root of a particle number N. Thus, in a coupling strength Ω_{R}/ω₀, as a propagating length Lₓ increases, a particle number N that can interact increases. In addition, according to (Expression 17) or (Expression 18), a relative reaction rate constant κ₋/κ₀ exponentially increases with respect to a coupling strength Ω_{R}/ω₀, and thereby eventually, the relative reaction rate constant κ₋/κ₀ increases as a propagating length Lₓ increases. As a result, a longer propagating length Lₓ is better suited to the purpose of chemical reaction promotion by a vibrational coupling.

The second characteristic is that a propagating length Lₓ varies with a wavenumber (wavelength) by about one digit, which is rather large, for any metal. The third characteristic is that a variation by a metal type is approximately double-digit, which is also large.

Classifying the metals in terms of suitability for the purpose of chemical reaction promotion by a vibrational coupling, based on the aforementioned three characteristics related to wavenumber (wavelength) dependence of a propagating length Lₓ, silver, gold, aluminum, copper, tungsten, nickel, platinum, cobalt, iron, palladium, and titanium can be listed in descending order of suitability. Another material may be used as long as the real part of a dielectric function of the material is negative and has a large absolute value, and the imaginary part of the dielectric function has a small absolute value; and single-element metal, an alloy, metallic oxide, graphene, graphite, or the like that are not taken up here are also applicable.

[(2)-B: Vibrational Mode Possessed by Chemical Substance Used in Chemical Reaction and Requirement of Vibrational Mode]

A vibrational mode possessed by a chemical substance used in a chemical reaction and a requirement of the vibrational mode will be discussed. A molecule composed of N atoms has 3N−6 vibrational modes excluding degrees of freedom of translation and rotation (3N−5 for a linear molecule). Among such vibrational modes, a vibrational mode usable for a vibrational coupling is limited to dipole allowance. The reason is that, as indicated in (Expression 1), when a transition dipole moment d is zero, Rabi splitting energy hΩ_{R} becomes zero, and consequently, a coupling strength Ω_{R}/ω₀ also becomes zero. Actually, substituting Ω_{R}/ω₀=0 into (Expression 17) or (Expression 18) yields κ₋/κ₀=1, therefore chemical reaction promotion by a vibrational coupling is not provided. Dipole allowance refers to infrared activity, meaning that there is infrared absorption. An infrared-active vibrational mode includes anti-symmetric stretching vibration, anti-symmetric deformation vibration, or the like when the chemical substance has a center of symmetry, whereas, in the absence of a center of symmetry, symmetric stretching vibration, symmetric deformation vibration, or the like are also included in addition to the anti-symmetric stretching vibration, the anti-symmetric deformation vibration, or the like. According to (Expression 1), Rabi splitting energy hΩ_{R} is proportional to a transition dipole moment d. In other words, as a transition dipole moment d increases, a coupling strength Ω_{R}/ω₀ increases, and a relative reaction rate constant κ₋/κ₀ also increases, based on (Expression 17) or (Expression 18). Namely, a vibrational coupling promotes a chemical reaction more rapidly when a vibrational mode has a larger transition dipole moment d.

TABLE 1
Comparison of transition dipole moments
of various vibration modes

| | | Transition dipole |
|---|---|---|
| | | moments |
| Molecule | Vibration type | [D: debye] |
| Ethanethiol | S—H stretching vibration | 0.018 |
| Ammonia | N—H stretching vibration | 0.026 |
| Benzene | C—H stretching vibration | 0.034 |
| Methanol | O—H stretching vibration | 0.050 |
| Acetic acid | O—H stretching vibration | 0.065 |
| Methane | C—H stretching vibration | 0.100 |
| Ozone | O═O═O stretching vibration | 0.187 |
| Acetone | C═O stretching vibration | 0.224 |
| Methanol | C—O stretching vibration | 0.242 |
| Nitrogen dioxide | O═N═O stretching vibration | 0.297 |
| Carbon dioxide | O═C═O stretching vibration | 0.326 |
| Carbon dioxide | S═C═S stretching vibration | 0.333 |
| Water | O—H stretching vibration | 0.420 |
| Isocyanate | N═C═O stretching vibration | 0.555 |
| Ketene | C═C═O stretching vibration | 0.611 |

Table 1 lists literature values or experimental values of transition dipole moments d of various vibrational modes. The unit of a transition dipole moment d is expressed by debye (D, where 1 D=3.336×10⁻³⁰ C·m. Referring to Table 1, a general tendency is that a transition dipole moment d has a relatively larger value in a vibrational mode between different atoms rather than between the same atoms, in a vibrational mode between atoms with a small mass difference rather than between atoms with a large difference, a vibrational mode with a multiple bond rather than a single bond, and a vibrational mode with a long conjugated system rather than a short conjugated system. This tendency is also inherited to a degree of promotion of a chemical reaction by a vibrational coupling. In other words, a chemical substance including a vibrational mode of a multiple bond between atoms with a relatively small mass difference, such as a vibrational mode of each of C═N, C═O, C═P, C═S, N═O, N═P, N═S, and O═S is expected to further enjoy an effect of chemical reaction promotion by a vibrational coupling. In addition, since the vibrational mode of the OH group is as large as the transition dipole moment d=0.420 D, it is considered that the chemical reaction of the solute can be promoted by using a matter having an OH (OD) group such as water or alcohol as a solvent.

On one hand, a transition dipole moment d is vibrational mode inherent, that is, chemical substance inherent, and therefore cannot be changed once a reaction system is determined. On the other hand, according to a theory indicated by (Expression 1), Rabi splitting energy hΩ_{R} is proportional to the square root of a concentration of a matter C (C=N/V, where N is a particle number of a matter and V is a mode volume and further according to an experiment, the Rabi splitting energy hΩ_{R} is proportional to the 0.4-th power to the 0.5-th power of the concentration of the matter C. That is, theoretically Ω_{R} ∝C^{0.5} holds, and experimentally Ω_{R} ∝C^{0.4 to 0.5} holds. Consequently, in either case, as a means of raising a degree of promotion of a chemical reaction by a vibrational coupling, increasing a relative reaction rate constant κ₋/κ₀ by increasing a coupling strength Ω_{R}/ω₀ through increasing a concentration C is a versatile method. By use of (Expression 17), an effect of magnitude of a concentration C on a relative reaction rate constant κ₋/κ₀ can be quantitatively estimated. The concentration dependence of this relative reaction rate constant: κ₋/κ₀ is summarized as follows: Raising a concentration of a chemical substance is effective as a means of increasing a reaction rate constant under a vibrational coupling unless a coupling strength enters the deep strong coupling region expressed by (Expression 5). In particular, a concentration increase brings about a remarkable effect to a vibrational strong coupling and a vibrational ultra strong coupling. In the chemical reaction that changes the solute, the concentration of the solvent is significantly higher than the concentration of the solute. Therefore, when vibrational coupling is generated in the solvent, the reaction rate constant is greatly increased. For example, when the solvent is pure water, the molar concentration of light water (H₂O) is 55.51 M (M=mol·L⁻¹, L: liter), and the molar concentration of heavy water (D₂O) is 55.27 M. Both are extremely high concentrations. In general, in an aqueous solution reaction involving water, water is in great excess of the solute of the reactant source material, and the concentration of water hardly changes even if the reaction proceeds. Therefore, if the vibrational coupling is applied to water serving as a solvent, significant reaction acceleration can be expected. The same arguments applies to cases where ethanol (molar concentration: 17.13 M), methanol (molar concentration: 24.71 M), propylene glycol (molar concentration: 13.62 M), ethylene glycol (molar concentration: 17.94 M), glycerin (molar concentration): 13.69 M), a mixture of light water and heavy water, hydrogen peroxide solution (molar concentration: 32.63 M), and the like are also used as a solvent. In particular, in the case of light water, heavy water, hydrogen peroxide solution, a mixture of light water and heavy water, ethylene glycol, propylene glycol, two OH groups (OD groups) that can be vibrationally coupled in one molecule, three in the case of glycerin. As a result, the concentration effect on the reaction acceleration is doubled and tripled, respectively. In the following description, in view of the fact that water (including light water and heavy water) occupies a special position in life, the global environment, and industry, water in a vibrational ultra strong coupling state (0.1≤Ω_{R}/ω₀≤1.0) will be referred to as ultra strong coupling water.

[(2)-C: Vibrational Coupling Between Optical Mode and Vibrational Mode, and Requirement of Vibrational Coupling]

A vibrational coupling between an optical mode and a vibrational mode, and a requirement of the vibrational coupling will be discussed. A condition for achieving a vibrational coupling by use of the Fabry-Pérot cavity 7 is expressed by (Expression 25) below using a wavenumber of an optical mode kₘ and a wavenumber of a vibrational mode ω₀.

ω₀=kₘ=mk₀ (m=1,2,3, . . . ) (Expression 25)

where k₀ denotes an optical mode interval, as discussed above. As defined in Item (1)-A, ω₀ denotes an angular frequency (unit: s⁻¹); however, since a physical quantity acquired by an experiment is a wavenumber (unit: cm⁻¹), ω₀ is hereinafter referred to as a wavenumber. In addition, since (energy)=(Planck constant)×(frequency)=(Dirac constant)×(angular frequency)=(Planck constant)×(speed of light)×(wavenumber) holds, energy, a frequency, an angular frequency, and a wavenumber are interchangeable.

As illustrated in FIG. 3(A), when (Expression 25) is satisfied, a vibrational coupling system in (b) is generated through mixing of a vibration system in (a) and an optical system in (c). Referring to FIG. 3(B), in a chemical reaction, activation energy in a vibrational coupling system is reduced from Eₐ₀ to E₋ as compared with an original system, as indicated by (Expression 13). Consequently, as indicated by (Expression 17) or (Expression 18), a reaction rate constant of the vibrational coupling system κ₋ increases as compared with a reaction rate constant of the original system κ₀. In particular, under the strong coupling condition expressed by (Expression 3) and the ultra strong coupling condition expressed by (Expression 4), the relative reaction rate constant κ₋/κ₀ takes a value ranging from several digits to several tens of digits, and an effect of chemical reaction promotion by a vibrational coupling can be most significantly enjoyed. It is known by experiment that an equivalent advantageous effect of chemical reaction promotion can be realized even when a wavenumber kₘ of an optical mode and a wavenumber ω₀ of a vibrational mode do not strictly match in (Expression 25). In other words, ω₀≈kₘ=mk₀ (wherein m=1, 2, 3, . . . ) holds experimentally.

In (Expression 25), ω₀ denotes a wavenumber of a vibrational mode of a chemical coupling constituting a chemical substance serving as a row material in a desired chemical reaction or a wavenumber of a vibrational mode of a chemical coupling (group) included in a chemical substance serving as a solvent. In other words, a wavenumber of a vibrational mode in an original system ω₀ is a constant value inherent to a chemical substance in the original system, and therefore there is no degree of freedom for adjustment. Thus, when a vibrational coupling is used for promotion of a chemical reaction, a wavenumber of an optical mode kₘ is to be adjusted to match a wavenumber of a vibrational mode ω₀. As discussed in Item (2)-A, an optical mode is composed of the first optical mode, the second optical mode, the third optical mode, . . . , the m-th optical mode, and therefore there are m choices, which satisfy the condition in (Expression 25). An optical mode best suited for chemical reaction promotion by a vibrational coupling is not obvious. As illustrated in aforementioned FIG. 4(A) to FIG. 4(D), as a coupling strength Ω_{R}/ω₀ increases, a relative reaction rate constant κ₋/κ₀ increases, according to (Expression 17) or (Expression 18). Namely, which optical mode is best suited for increasing a relative reaction rate constant κ₋/κ₀ can be reduced to a discussion of which optical mode increases a coupling strength Ω_{R}/ω₀. Optical mode number dependence of the coupling strength Ω_{R}/ω₀ is summarized as follows: Rabi splitting energy hΩ_{R} takes a nearly constant value regardless of which of the optical modes from the first optical mode to at least the twentieth optical mode is used. Therefore, for a purpose of use in chemical reaction promotion by a vibrational coupling, the same effect can be practically expected regardless of the ordinal number of the optical mode to be used.

[(3) Process of Materializing Vibrational Coupling Chemical Reaction Device and Producing and Processing Desired Chemical Substance]

A process of materializing a vibrational coupling chemical reaction device in which a purpose of performing a vibrational coupling is compatible with a purpose of performing a chemical reaction, and producing and processing a desired chemical substance by use of the device will be discussed on the basis of Item (2), according to Items (3)-A, (3)-B, and (3)-C described below:

(3)-A: Capacity increase of a vibrational coupling chemical reaction device by a linear cavity

(3)-B: Providing Multimode of a vibrational coupling chemical reaction device by a linear cavity

(3)-C: Modularization, unitization, and systematization of a vibrational coupling chemical reaction device

[(3)-A: Capacity Increase of Vibrational Coupling Chemical Reaction Device by Linear Cavity]

First, a concept of a linear cavity and capacity increase of a vibrational coupling chemical reaction device by a linear cavity will be discussed. One hand, the Fabry-Pérot cavity 7 in FIGS. 5(A) to 5(C) has an advantage of having a simple structure and being easy to produce, on the other hand, because a confinement space of light is defined by a cavity length t, the Fabry-Pérot cavity 7 has a disadvantage of having a relatively small capacity as a chemical reaction container for a vibrational coupling. For example, referring to FIGS. 5(A) to 5(C), when a vibrational mode of a chemical substance with a wavenumber of 1000 cm⁻¹ is vibrationally coupled with an optical mode of the Fabry-Pérot cavity 7, assuming a refractive index of the chemical substance filling inside the cavity to be 1.5, a cavity length t is approximately 3.33 μm. A volume of a fillable chemical substance is merely approximately 3.33 cm³ even using a mirror plane 1 with one meter square. Expansion from a two-dimensional structure to a three-dimensional structure is effective for expanding capacity; however, a structure obtained by simply laminating several Fabry-Pérot cavities 7 makes production very difficult. For a purpose of overcoming the disadvantages of the Fabry-Pérot cavity 7, that is, for a purpose of making optical electrical-field confinement compatible with capacity increase as a chemical reaction container while simplifying production, a scheme of accumulating linear cavities as discussed below has been devised as a result of concentrated researches.

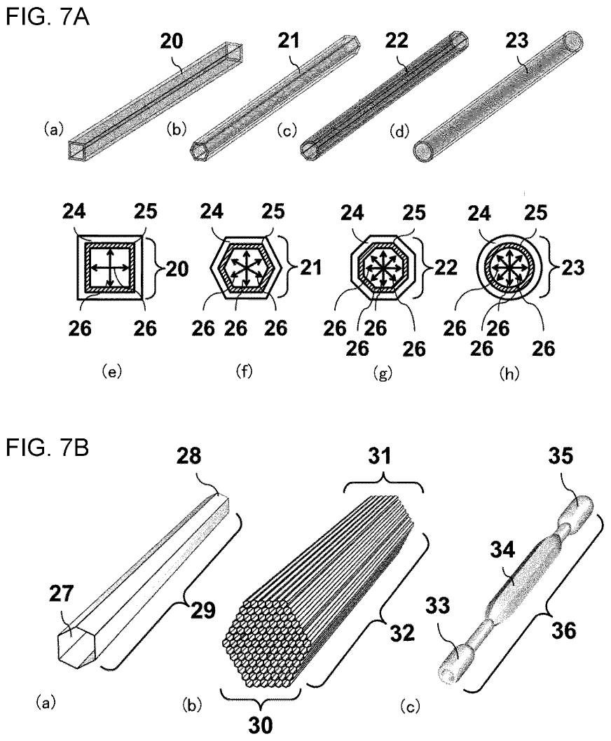

Referring to FIGS. 7(A) to 7(B), a cross-section of a linear cavity is a convex 2p-sided polygon (where p is an integer greater than or equal to 2) including p sets of two sides parallel to one another and the linear cavity has a sufficiently long prismatic shape in a direction perpendicular to the cross-section (a long-axis direction). In other words, a linear cavity is a sufficiently long 2p-sided prism having p sets of two mirror planes parallel to one another as sides. A shape of the cross-section defines a configuration of an optical mode such as a number of optical modes and a frequency of the optical mode. For example, the interval between two parallel sides in the cross section is equal to the cavity length t. Further, the long axis defines a capacity of a reactant material and further defines a reaction time when a flow reaction, to be discussed later, is performed. In other words, a reactant capacity or a reaction time is proportional to the length of the long axis. For example, (a) to (d) in FIG. 7(A) are schematic diagrams of various single linear cavities, and (e) to (h) are cross-sectional views of the respective cavities. In other words, (a) and (e) correspond to a parallelogrammatical linear cavity 20 at p=2, (b) and (f) correspond to a parallelo-hexagonal linear cavity 21 at p=3, (c) and (g) correspond to a parallelo-octagonal linear cavity 22 at p=4, and (d) and (h) correspond to an elliptical linear cavity 23 at p=co. As illustrated in the cross-sectional views in (e) to (h) of FIGS. 7(A) to 7(B), each single linear cavity includes inner mirror planes 25 and an outer linear cavity enclosure 24, and has an optical mode 26 resonating between parallel mirror planes facing one another.

FIG. 7(B) is a schematic diagram illustrating accumulating linear cavities. First, (a) shows a single linear cavity 29 including a raw material inlet 27 of the single linear cavity and a product outlet 28 of the single linear cavity. The raw material inlet 27 is an opening for introducing an object, for example, a fluid into the single linear cavity. The object introduced into the raw material inlet 27 is, for example, a raw material of the product (for example, a solvent and a solute). Examples of the solvent include those having an OH (OD) group such as water and alcohol. The object introduced into the raw material inlet 27 stays in the single linear cavity for a certain time. For example, when an object containing water stays in the single linear cavity, the staying water is in an ultra strong coupling state. The product outlet 28 is an opening for discharging at least one of an object placed in the single linear cavity and a product generated by a reaction of at least a part of the object. The discharged substance includes, for example, a product generated by a reaction of the solute, an unreacted raw material (if remaining), and a solvent.

Then, (b) depicts a linear cavity accumulation 32 in which single linear cavities 29 are aggregated, and a raw material inlet of the linear cavity accumulation 30 and a product outlet of the linear cavity accumulation 31 are similarly included. Finally, (c) represents a vibrational coupling chemical reaction device module 36 in which a linear cavity accumulation 32 is housed in a chamber of the linear cavity accumulation 34, and a raw material inlet of the vibrational coupling chemical reaction device module 33 and a product outlet of the vibrational coupling chemical reaction device module 35 are included. Capacity increase as a chemical reaction container is intended by three-dimensionally bundling single linear cavities 29 into a linear cavity accumulation 32. When a single linear cavity 29 has a cross-sectional shape of a parallelogram or a parallelo-hexagon, the single linear cavities 29 can be closely accumulated, and therefore capacity can be increased without a dead space. As will be discussed later in the processing method, the linear cavity accumulation 32 is also easy to produce.

The product outlet 28 may be closed, and the raw material inlet 27 may also serve as the product outlet 28.

[(3)-B: Providing Multimode of Vibrational Coupling Chemical Reaction Device by Linear Cavity]

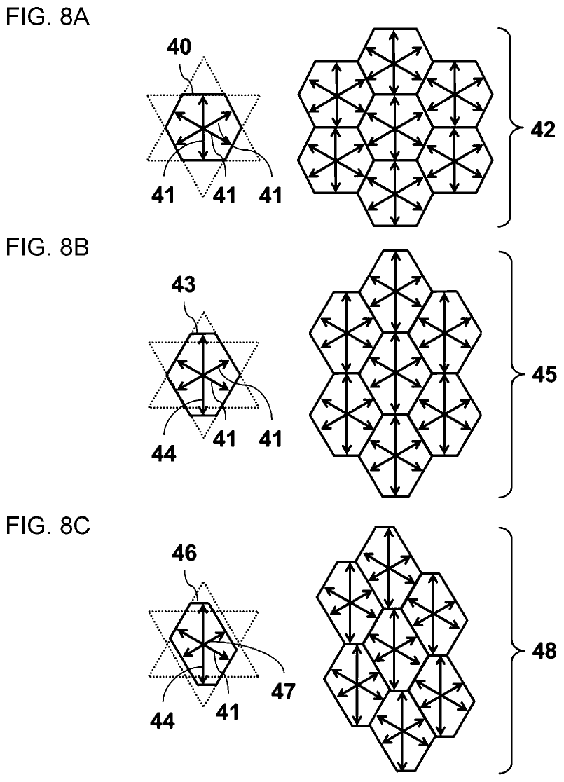

Next, providing multimode of a vibrational coupling chemical reaction device by a linear cavity will be discussed. A number of configurable optical modes in a linear cavity depends on a cross-sectional shape of the cavity. In other words, a linear cavity makes it possible to multiply a number of vibrational modes that can vibrationally couple simultaneously, thereby enabling a multimode operation. A specific example is shown in FIGS. 8(A) to 8(C). FIGS. 8(A) to 8(C) illustrate cross-sectional views of various single parallelo-hexagonal linear cavities and cross-sectional views of parallelo-hexagonal linear cavity accumulations.

FIG. 8(A) illustrates a case that a cross-sectional shape is a regular hexagon, and each of a single regular-hexagonal linear cavity 40 and a regular-hexagonal linear cavity accumulation 42 has optical modes 41 which are spatially three independent modes but energetically degenerate to one mode. Thereby, in the case of FIG. 8(A), each of the single regular-hexagonal linear cavity 40 and the regular-hexagonal linear cavity accumulation 42 can vibrationally couple with only one vibrational mode possessed by a chemical substance.

FIG. 8(B) illustrates a case that a cross-sectional shape is an isosceles parallelo-hexagon in which two sets out of six sides facing one another have the same length but the remaining set has a length different from the other two sets. Each of a single linear cavity 43 having an isosceles-parallelo-hexagonal cross-section and a linear cavity accumulation 45 obtained by accumulating a plurality of single linear cavities 43 has three spatially independent modes (three sets of two-sides facing one another) including, in terms of energy, a first optical mode 41 and a second optical mode 44 energetically different from the optical mode 41. Accordingly, in the case of FIG. 8(B), each of the single linear cavity 43 and the linear cavity accumulation 45 can vibrationally couple simultaneously with two different vibrational modes possessed by a chemical substance.

FIG. 8(C) illustrates a case that a cross-sectional shape is an inequilateral parallelo-hexagon in which all three sets out of six sides facing one another have different lengths. Each of a single linear cavity 46 having an inequilateral-parallelo-hexagonal cross-section and a linear cavity accumulation 48 obtained by accumulating a plurality of single linear cavities has three spatially and energetically independent modes, an optical mode 41, an optical mode 44, and an optical mode 47. Accordingly, in the case of FIG. 8(C), each of the single linear cavity 46 and the linear cavity accumulation 48 can vibrationally coupling simultaneously with three different vibrational modes possessed by a chemical substance.

In general, when a cross-sectional shape is a parallelo-2p-sided polygon (where p is an integer greater than or equal to 2), a number of spatially independent optical modes is p. For example, the parallelogrammatical linear cavity 20 has two optical modes, the parallelo-hexagonal linear cavity 21 has three optical modes, and the parallelo-octagonal linear cavity 22 has four optical modes. The elliptical linear cavity 23 can be assumed to have an infinite number of sides. In this case, there are theoretically infinite spatially independent optical modes. When a cross-sectional shape is a regular 2p-sided polygon, and all p sets of parallel sides have the same length, a number of spatially independent optical modes is p; however, because all modes degenerate energetically and have the same frequency, practically, there is only one optical mode. Accordingly, a regular 2p-sided polygonal linear cavity can vibrationally couple with only one vibrational mode possessed by a chemical substance. Further, when a cross-sectional shape is an inequilateral parallelo-2p-sided polygon and all p sets of parallel sides have different lengths, there are p spatially and energetically independent optical modes. Thus, an inequilateral parallelo-2p-sided polygonal linear cavity can vibrationally couple simultaneously with p different vibrational modes possessed by a chemical substance. Furthermore, when a cross-sectional shape is a general 2p-sided polygon and lengths of p sets of parallel sides can be classified into q, a number of spatially independent optical modes is p, whereas a number of energetically different optical modes is q. As a result, a general 2p-sided-polygonal linear cavity can vibrationally couple simultaneously with q different vibrational modes possessed by a chemical substance.

As discussed above, by defining a cross-sectional shape of a linear cavity, the linear cavity can vibrationally couple with a single to a multiple of vibrational modes possessed by a chemical substance, that is, can realize a multi-mode operation, thereby enabling to handle diverse chemical reactions. In particular, in a case of plural kinds of chemical substances as raw materials, a linear cavity can simultaneously activate vibrational modes related to a chemical reaction in each raw material, thereby exhibiting outstanding performance in synergistically accelerating a reaction rate of the entire chemical reaction.

[(3)-C: Modularization, Unitization, and Systematization of Vibrational Coupling Chemical Reaction Device]

Modularization, unitization, and systematization of a vibrational coupling chemical reaction device will be discussed.

The reason why modularization of a chemical reaction device can be provided is derived from the following facts: that the principle of chemical reaction promotion does not require preparation of a specific elementary composition and surface state for each chemical reaction as is the case with a normal catalytic action, and that it is only necessary to prepare an optical mode, which is determined solely by a structure and resonates specifically with a vibrational mode related to a chemical reaction. Thus, according to the example embodiment, because a frequency of an optical mode is determined solely by a cavity length, it is very easy to standardize module products. For example, preparing a plurality of vibrational coupling chemical reaction device modules 36 with slightly different cavity lengths (refer to (c) of FIG. 7(B)) allows to handle reaction promotion of various chemical reactions. Further, just standardizing the raw material inlet 33 and the product outlet 35, unitization and systematization can be freely achieved as will be discussed later. Furthermore, scale-up or scale-down of the vibrational coupling chemical reaction device module 36 may be performed on the basis of a production amount/throughput of a product.

In addition to an advantage of being capable of capacity increase by accumulation described in the previous item, the vibrational coupling chemical reaction device module 36 illustrated in FIGS. 7(A) to 7(B) has another advantage as follows: it is capable of continuously performing a series of processes including taking in a raw material of a chemical substance, causing a reaction, and then taking to out a product. This advantage is derived from a characteristic that the linear cavity accumulation 32 has a tubular shape and includes the raw material inlet 27 and the product outlet 28. These characteristics enable a flow-type chemical reaction. The vibrational coupling chemical reaction device module 36 is adaptable for a flowing chemical substance as follows: any fluid regardless of whether the fluid is gas, liquid, or solid is applicable, and single-chemical-material gas, mixed gas containing a chemical substance and carrier gas, an undiluted solution or melt of a single-chemical-material, a solution containing a chemical substance, emulsion, suspension, supercritical flow, and powder.

The advantage that the vibrational coupling chemical reaction device module 36 is capable of a flow-type chemical reaction contributes to unitization and systematization of the device. Further, by connecting a modularized vibrational coupling chemical reaction device to a container housing a raw material and a container storing a product via a proper channel, a chemical reaction unit, which constitutes an element corresponding to each process of a chemical reaction, can be constructed. Furthermore, a large-scale and complicated chemical reaction system, in which a plurality of chemical reaction units are connected to one another through a proper channel, can be constructed. Namely, each process of a chemical reaction can be unitized as a result of modularization of the vibrational coupling chemical reaction device, and the entire process of the chemical reaction can be systematized by connecting these units as a result of unitization of each process of the chemical reaction.

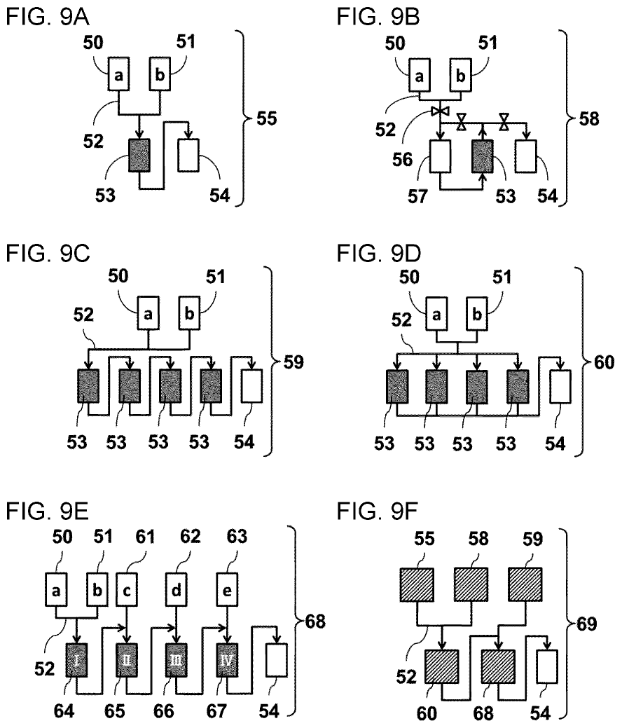

FIGS. 9(A) to 9(F) illustrates chemical reaction units and a chemical reaction system that are introduced by modularization of the vibrational coupling chemical reaction device. FIG. 9(A) depicts a basic-type vibrational coupling chemical reaction device unit 55, FIG. 9(B) shows a circulation-type vibrational coupling chemical reaction device unit 58, FIG. 9(C) represents a serial-type vibrational coupling chemical reaction device unit 59, FIG. 9(D) elucidates a parallel-type vibrational coupling chemical reaction device unit 60, FIG. 9(E) exemplifies a sequential-type vibrational coupling chemical reaction device unit 68, and FIG. (F) illustrates a vibrational coupling chemical reaction device system 69.

FIG. 9(A) illustrates a most basic chemical reaction unit according to the example embodiment of the present invention that promotes a chemical reaction between a chemical substance raw material a housed in a raw material container a and a chemical substance raw material b housed in a raw material container b51, by use of a vibrational coupling chemical reaction device module 53, and subsequently to the chemical reaction, performs a process of storing a product in a product container 54. Transfer of raw materials between the raw material container a50 and the raw material container b51, and the vibrational coupling chemical reaction device module 53, and transfer of a product between the vibrational coupling chemical reaction device module 53 and the product container 54 are performed by use of a channel 52. A chemical substance raw material a is housed in a raw material container a50, for example in the state dissolved in water or alcohol as a solvent. The same applies to the chemical substance raw material b.

FIG. 9(B) illustrates a chemical reaction unit circulating a reactant into a vibrational coupling chemical reaction device module 53, and the unit is suited for a reaction of a large amount of reactant and lengthening of a reaction time. In this chemical reaction unit, the raw material container a50 and the raw material container b51 are connected to the reactant container 57 via the first channel. A valve 56 is provided in this channel. The outlet of the reactant container 57 and the inlet of the vibrational coupling chemical reaction device module 53 are connected by a second channel, and the inlet of the reactant container 57 and the outlet of the vibrational coupling chemical reaction device module 53 are connected by a third channel. Further, the outlet of the vibrational coupling chemical reaction device module 53 and the product container 54 are connected by a fourth channel. The valve 56 is provided in each of the first channel, the third channel, and the fourth channel. A process of first storing a chemical substance raw material a housed in a raw material container a50 and a chemical substance raw material b housed in a raw material container b51 into a reactant container 57, circulating the raw materials between the reactant container 57 and the vibrational coupling chemical reaction device module 53 by properly operating a valve 56, and subsequently to promoting the chemical reaction, storing a product into a product container 54 is performed.

FIG. 9(C) illustrates a chemical reaction unit in which vibrational coupling chemical reaction device modules 53 are connected in series, and the unit is suited for lengthening a reaction time. A chemical reaction between a chemical substance raw material a housed in a raw material container a50 and a chemical substance raw material b housed in a raw material container b51 is sequentially promoted by a vibrational coupling chemical reaction device module 53 connected in series. The product after the chemical reaction is stored in the product container 54.

FIG. 9(D) illustrates a chemical reaction unit in which vibrational coupling chemical reaction device modules 53 are connected in parallel, and the unit is suited for a reaction of a large amount of reactant. A chemical reaction between a chemical substance raw material a housed in a raw material container a50 and a chemical substance raw material b housed in a raw material container b51 is promoted by each of the vibrational coupling chemical reaction device modules 53 connected in parallel, and a product after the chemical reaction is stored into a product container 54.

FIG. 9(E) illustrates a chemical reaction unit sequentially performing a plurality of chemical reactions, and the unit is suited for a multistage reaction. In this chemical reaction unit, an outlet and a raw material container of a certain vibrational coupling chemical reaction device module are connected to an inlet of the next vibrational coupling chemical reaction device module. For example, a chemical reaction between a chemical substance raw material a housed in a raw material container a50 and a chemical substance raw material b housed in a raw material container b51 is promoted by use of a vibrational coupling chemical reaction device module I64. Subsequently to the chemical reaction, a chemical reaction between a product of the previous chemical reaction and a chemical substance raw material c housed in a raw material container c61 is promoted by use of a vibrational coupling chemical reaction device module II65. Subsequently to the chemical reaction, a chemical reaction between a product of the previous chemical reaction and a chemical substance raw material d housed in a raw material container d62 is promoted by use of a vibrational coupling chemical reaction device module III66. Subsequently to the chemical reaction, a chemical reaction between a product of the previous chemical reaction and a chemical substance raw material e housed in a raw material container e63 is promoted by use of a vibrational coupling chemical reaction device module IV67, and subsequently to the chemical reaction, a product of the chemical reaction is stored into a product container 54.

FIG. 9(F) illustrates a reaction device system combining the chemical reaction units shown in FIG. 9(A) to FIG. 9(E), and the system is suited for performing an entire process of a complicated chemical reaction at once. In this example, a process of performing a chemical reaction between a product produced by the basic-type vibrational coupling chemical reaction device unit 55 and a product produced by the circulation-type vibrational coupling chemical reaction device unit 58 by use of the series-type vibrational coupling chemical reaction device unit 59, then performing a chemical reaction between a product of the previous chemical reaction and a product produced by the serial-type vibrational coupling chemical reaction device unit 59 by use of the sequential-type vibrational coupling chemical reaction device unit 68, and finally, storing a product of the chemical reaction into a product container 54. This is an example, and combination of various chemical reaction units can be performed.

As described above, modularization, unitization, and systematization according to the example embodiment of the present invention can handle diverse production/processing scales ranging from small-scale fewer-item production to mass production and enables easy recombination, rearrangement, and exchange as needed, and therefore is useful in greatly reducing production/processing costs and greatly improving productivity.

[Description of Advantageous Effects]

As described above, the vibrational coupling chemical reaction device according to the example embodiment of the present invention can decrease vibrational energy and reduce activation energy of a chemical reaction, by vibrationally coupling an optical mode formed by an optical electrical-field confinement structure with a vibrational mode of a chemical substance related to the chemical reaction, and therefore can promote the chemical reaction. This effect increases with the concentration. Therefore, when vibrational coupling is generated in the solvent in the chemical reaction that changes the solute, the reaction rate constant is greatly increased.

[Description of Production Method]

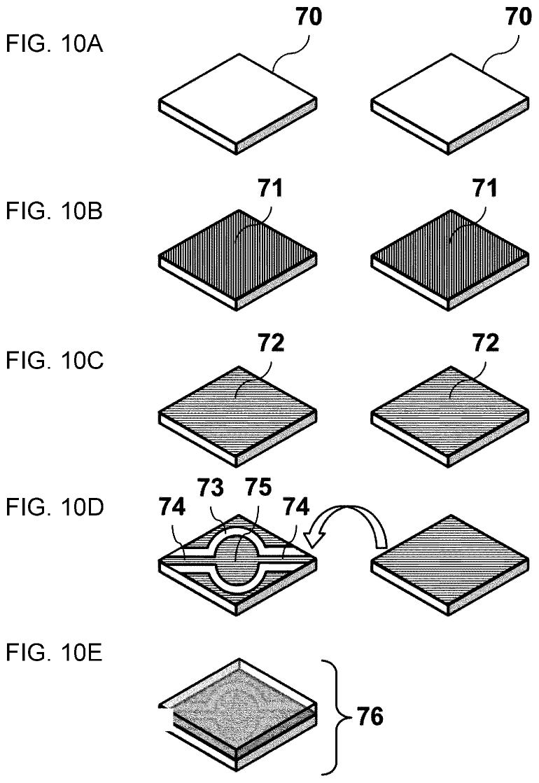

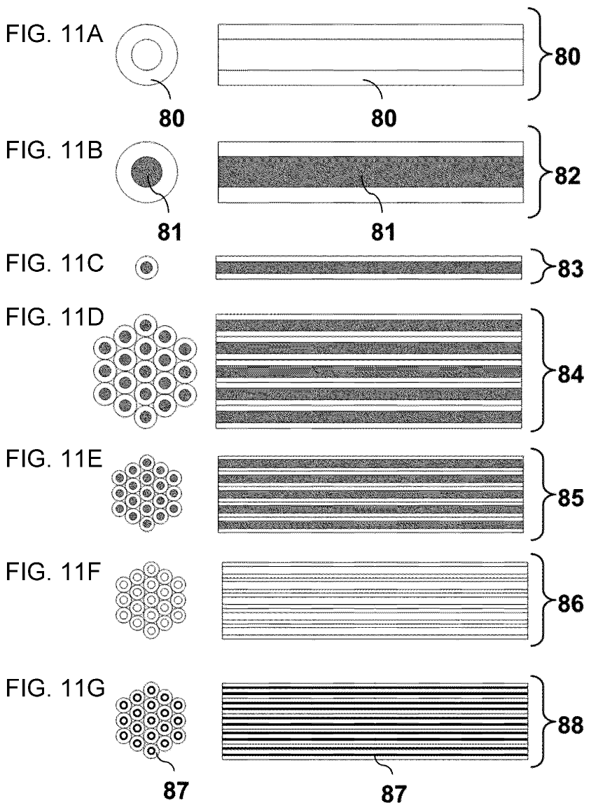

A production method according to the example embodiment will be discussed with reference to FIGS. 10(A) to 10(E) and FIGS. 11(A) to 11(G).

FIGS. 10(A) to 10(E) are schematic diagrams illustrating an example of a process of producing a Fabry-Pérot-cavity-type vibrational coupling chemical reaction device.

First, as illustrated in FIG. 10(A), a substrate 70 serving as an enclosure of a cavity is prepared. A surface of the substrate 70 is required to be smooth, and is desirably optically polished such that the unevenness of the surface is not more than a half-wavelength in an infrared region (1 to 100 μm). A material of the substrate 70 may be selected from a wide range of materials such as metal, a semiconductor, and an insulator, on condition that a sufficient enclosure strength is secured. It is desirable to use germanium (Ge), zinc selenide (ZnSe), zinc sulfide (ZnS), gallium arsenide (GaAs), or the like which is relatively transparent in the infrared region, when evaluated by an infrared absorption spectroscopy method or the like. A thickness of the substrate 70 has only to be sufficient for maintaining the enclosure strength.

Next, as illustrated in FIG. 10(B), a mirror plane 71 of the cavity is formed on the substrate 70. As for a material of the mirror plane 71, silver and gold are most excellent, then aluminum, copper, and tungsten are desirable, and nickel, platinum, cobalt, iron, palladium, and titanium are fair, as described in Item (2)-A. Another material may be used as long as the real part of a dielectric function of the material is negative and has a large absolute value, and the imaginary part of the dielectric function has a small absolute value; and single-element metal, an alloy, metallic oxide, graphene, graphite, or the like are also applicable. While a thickness of around 5 nm is sufficient for the mirror plane 71, it is desirable that the thickness be less than or equal to 25 nm from a viewpoint of infrared light transmission, when evaluated by an infrared absorption spectroscopy method or the like. As the formation method of the mirror plane 71, a common film-forming method like dry film-forming such as sputter film-forming, resistive heat evaporation, or electron beam evaporation, or like or wet film-forming such as electrolytic plating or electroless plating may be used.

Next, as illustrated in FIG. 10(C), a protective film 72 is formed on the mirror plane 71. The protective film 72 is formed for a purpose of preventing the mirror plane 71 from contacting chemical substances. A thickness of around 100 nm is sufficient for the protective film 72. While a material of the protective film 72 depends on a chemical reaction being used, silicon oxide (SiO₂) being chemically inert is generally used. As the formation method of the protective film 72, a dry method such as sputter film-forming or the like, or a wet method such as vitrifying film-forming by perhydropolysilazane [(—SiH₂—NH—)ₙ] may be used.

Next, as illustrated in FIG. 10(D), a spacer 73 and a channel 74 for forming a chemical substance storage 75 are arranged on a substrate 70 on which a protective film 72 and a mirror plane 71 are formed. Another substrate 70 on which a protective film 72 and a mirror plane 71 are formed is overlaid on top of the former substrate 70. The thickness of the spacer 73 defines a cavity length. Accordingly, the thickness of the spacer 73 needs to be adjusted in accordance with (Expression 21) for each frequency of a vibrational mode of a chemical substance used in a chemical reaction, and roughly has the length of a wavelength of infrared light (1 to 100 μm). The thicknesses of the channel 74 and the spacer 73 are preferably the same.

As a material of the spacer 73, a plastic resin thin film a thickness of which can be adjusted to some extent, such as Teflon (Registered Trademark) or Mylar (Registered Trademark), is suited. In particular, since Teflon and Mylar are chemically inert, they have a high utility value as the spacer 73. However, it is difficult to form a thin film with a thickness of less than or equal to 6 μm by using a plastic resin, and therefore when the thickness of the spacer 73 is less than 6 μm, ductile metal, such as titanium, steel, gold, and copper, may be selected as a material of the spacer 73. When a metallic spacer 73 is used, it is preferable to inactivate the surface of the spacer 73 by a plastic resin such as Teflon, an oxide film such as silicon oxide, or the like, if necessary.

FIG. 10(E) illustrates a final diagram of the Fabry-Pérot-cavity-type vibrational coupling chemical reaction device 76. Practically, the device is used as a device for promoting a chemical reaction by housing the device in a proper holder including a loading mechanism for cavity length adjustment. At this time, the chemical substance raw material is introduced into one opening (raw material inlet) of the channel 74. Then, the product is discharged from the other opening (product outlet) of the channel 74.

FIGS. 11(A) to 11(G) are cross-sectional views illustrating an example of a process of producing a linear-cavity-type vibrational coupling chemical reaction device according to the example embodiment of the present invention.

First, as illustrated in FIG. 11(A), a glass tube 80 serving as an enclosure of a linear cavity is prepared. As for a size of the glass tube 80, a diameter of around 1 cm and a length of around 10 cm are sufficient for a small-scale linear cavity. For a large-scale linear cavity, the size is enlarged according to a necessary scale. While soda glass, lead glass, borosilicate glass, quartz glass, sapphire glass, or the like may be used as a material of the glass tube 80, soda glass, lead glass, or borosilicate glass is suited from a viewpoint of ease of melt processing.

Next, as illustrated in FIG. 11(B), acid-soluble glass 81 is filled into the glass tube 80. The acid-soluble glass 81 is special glass soluble in hydrochloric acid, nitric acid, sulfuric acid, or the like, and plays a role of preventing the glass tube 80 from internal fusion-bonding in a thinning process in a downstream step. The glass tube 80 is preheated, and then an acid-soluble-glass-filled glass tube 82 is obtained by pouring the melted acid-soluble glass 81 into the glass tube 80.

Next, as illustrated in FIG. 11(C), the acid-soluble-glass-filled glass tube 82 is thinned. The acid-soluble-glass-filled glass tube 82 is heated to a proper temperature and then drawn in a tube-axis direction. As a result, a thinned acid-soluble-glass-filled glass tubes 83 having a diameter of about 100 μm is obtained. Next, the thinned acid-soluble-glass-filled glass tube 83 is cut at certain intervals to be used in a downstream process.

Next, as illustrated in FIG. 11(D), thinned acid-soluble-glass-filled glass tubes 83 are aligned and fusion-bonded. Specifically, the thinned acid-soluble-glass-filled glass tubes 83 are aligned and bundled in such a way that tube axes can be parallel to one another, the thinned acid-soluble-glass-filled glass tubes 83 are fusion-bonded with one another by heating at a proper temperature. As a result, a thinned acid-soluble-glass-filled glass tube accumulation 84 is acquired. A thinned acid-soluble-glass-filled glass tube accumulation 84 having a uniform pitch can be easily acquired by using a glass tube for molding and aligning and fusion-bonding the thinned acid-soluble-glass-filled glass tubes 83 in the tube. Further, a cross-sectional shape of each thinned acid-soluble-glass-filled glass tube constituting the thinned acid-soluble-glass-filled glass tube accumulation 84 is controlled by an alignment method when fusion-bonding is performed. For example, when aligning and fusion-bonding are performed, the sectional shape becomes a regular hexagon when the glass tubes are aligned to be trigonal-lattice-like, and the surface shape becomes a square when the glass tubes are aligned to be tetragonal-lattice-like.

Next, as illustrated in FIG. 11(E), the thinned acid-soluble-glass-filled glass tube accumulation 84 are further thinned. The thinned acid-soluble-glass-filled glass tube accumulation 84 is heated in a tube-axis direction at a proper temperature and then drawn. As a result, a re-thinned acid-soluble-glass-filled glass tube accumulation 85 is acquired. An inside diameter of a re-thinned acid-soluble-glass-filled glass tube constituting the re-thinned acid-soluble-glass-filled glass tube accumulation 85 defines a cavity length. Accordingly, the inside diameter is adjusted in accordance with (Expression 21) for each frequency of a vibrational mode of a chemical substance used in a chemical reaction. The inside diameter roughly falls within a wavelength range in the infrared region (1 to 100 μm). A cross-sectional shape of a re-thinned acid-soluble-glass-filled glass tube constituting the re-thinned acid-soluble-glass-filled glass tube accumulation 85 can be controlled by performing compression processing from the side in addition to the drawing processing when the heating processing is performed. For example, when a sectional shape of each thinned acid-soluble-glass-filled glass tube constituting the thinned acid-soluble-glass-filled glass tube accumulation 84 undergoing the heating processing is a regular hexagon and only the drawing processing is performed, a cross-sectional shape of a re-thinned acid-soluble-glass-filled glass tube constituting the re-thinned acid-soluble-glass-filled glass tube accumulation 85 inherits a regular hexagon, whereas when compression processing from the side is added to the drawing processing, the cross-sectional shape can be transformed into an isosceles parallelo-hexagon or an inequilateral parallelo-hexagon illustrated in FIGS. 8(A) to 8(C).

Next, as illustrated in FIG. 11(F), an acid-soluble glass is cored from the re-thinned acid-soluble-glass-filled glass tube accumulation 85. A re-thinned glass tube accumulation 86 is obtained by dipping the re-thinned acid-soluble-glass-filled glass tube accumulation 85 in proper acid such as hydrochloric acid, nitric acid, or sulfuric acid, and dissolving acid-soluble glass into the acid.

Next, as illustrated in FIG. 11(G), a mirror plane 87 is formed inside the re-thinned glass tube accumulation 86. Electroless plating is suited for the mirror plane formation. Subsequently to being washed with a proper solvent and undergoing proper preprocessing, the re-thinned glass tube accumulation 86 is dipped into an electroless plating solution. A thickness of the mirror plane 87 can be adjusted by a dipping time. The mirror plane 87 is a metal film of 5 nm or more, for example. On the other hand, when a material of the glass tube 80 is lead glass, a metal lead thin film can be grown on the inner surface of the re-thinned glass tube accumulation 86 by hydrogen-reducing the tube accumulation in a vacuum, and then the mirror plane 87 can be formed by electroless plating or electrolytic plating with the lead thin film as a foothold. In this case, excellent adhesion between the mirror plane 87 and the inner surface of the glass as well as a uniform mirror plane 87 can be achieved. Additionally, a graphene film or a graphite film may be formed as the mirror plane 87 by liquid phase growth. In this case, liquid metal, such as gallium (Ga), containing carbon is impregnated inside the tube of the re-thinned glass tube accumulation 86 when heating is performed, and a graphene film is grown when cooling is performed. A graphene film and a graphite film excellently adhere to the inner surface of the glass, and a very uniform mirror plane 87 can be acquired. In addition, a protective film is formed on the mirror plane 87, if necessary. A thickness of around 100 nm is sufficient for the protective film. While a material of the protective film depends on a chemical reaction being used, silicon oxide (SiO₂) being chemically inert is generally used. As the formation method of the protective film, a dry method such as sputter film-forming or the like, or a wet method such as vitrifying film-forming by perhydropolysilazane [(—SiH₂-NH—)ₙ] may be used. However, when a graphene film or a graphite film is employed as the mirror plane 87, the graphene film or the graphite film itself is inert to a chemical reaction except for oxidation, and therefore the protective film forming process is unnecessary unless the chemical reaction being used is oxidation. By the processes described above, a linear cavity accumulation 88 is acquired.

As illustrated in (c) in FIG. 7(B), by housing the linear cavity accumulation 88 in a proper holder or enclosure including a chamber for mounting the linear cavity accumulation 88, a chemical substance raw material inlet, and a product outlet, a linear-cavity-type vibrational coupling chemical reaction device is completed.

### EXAMPLES

Hereinafter, by evaluating a group of matters having an OH (OD) group, it will be shown that they exhibit a vibrational strong coupling state (0.01≤Ω_{R}/ω₀<0.1) from a very low concentration, and reach a vibrational ultra strong coupling state (0.1≤Ω_{R}/ω₀≤1.0) at a practical concentration. In particular, it will be shown that when an OH (OD) group-containing matter under vibrational coupling is used for a chemical reaction, the matter acts as a large excess of solvent, so that the chemical reaction can be significantly enhanced while maintaining high coupling strength Ω_{R}/ω₀.

### Example 1

In this example, the concentration dependence of the infrared transmission spectrum of light water (H₂O) and heavy water (D₂O) under vibrational coupling, and the concentration dependence of coupling strength Ω_{R}/ω₀ will be described. The point of this example is that when light water or heavy water is placed in an appropriate optical confinement structure, the optical mode and the vibrational mode cause vibrational coupling. In particular, both light water and heavy water are in an ultra strong coupling state at a concentration of about 9 M (mol·L⁻¹, L: Liters) or more, that is, becomes ultra strong coupling water. Details of this example will be described below.

Experimental procedure is as follows. Water was introduced into a Fabry-Pérot cavity that satisfies the resonance conditions for the OH group or OD group to resonate, and the infrared transmission spectrum was measured using a Fourier transform infrared spectroscopy (FT-IR) apparatus. The Fabry-Pérot cavity was produced by forming a gold (Au) film with a thickness of approximately 10 nm on a zinc selenide (ZnSe) window having a property of transmitting infrared rays using a sputtering method as a mirror plane, and then by forming a silicon dioxide (SiO₂) film having a thickness of approximately 100 nm using a solution process method as a protective film. The concentration of water was changed by mixing light water and heavy water to a certain mixing ratio. Since the wavenumbers of OH stretching vibration and OD stretching vibration are 3400 cm⁻¹ and 2500 cm⁻¹, respectively, the resonance conditions were set by adjusting the cavity length.

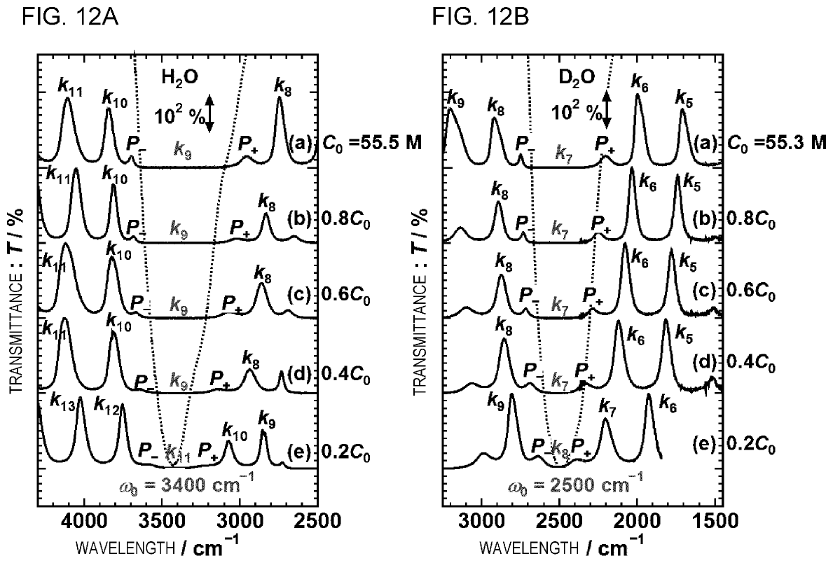

FIGS. 12(A) and 12(B) are infrared transmission spectra when a vibrational mode of OH stretching (FIG. 12(A): ω₀=3400 cm⁻¹) of light water and a vibrational mode of OD stretching of heavy water (FIG. 12(B): ω₀=2500 cm⁻¹) at various concentrations are vibrationally coupled with an optical mode of a Fabry-Pérot cavity, consequently being caused to Rabi-split into a P₋ state and a P₊ state. In the case of light water FIG. 12(A), the mixing ratio of light water and heavy water (relative concentration of light water) decreases from top to bottom. Specifically, (a) is infrared transmission spectrum at H₂O:D₂O=10:0 (C₀=55.5 M), (b) at H₂O:D₂O=8:2 (0.8C₀=44.4 M), (c) at H₂O:D₂O=6:4 (0.6C₀=33.3 M), (d) at H₂O:D₂O=4:6 (0.4C₀=22.2 M), and (e) at H₂O:D₂O=2:8 (0.2C₀=11.1 M). In the case of heavy water FIG. 12(B), the mixing ratio of heavy water and light water (relative concentration of heavy water) also decreases from top to bottom, as expected. Specifically, (a) is infrared transmission spectrum at D₂O:H₂O=10:0 (C₀=55.3 M), (b) at D₂O:H₂O=8:2 (0.8C₀=44.2 M), (c) at D₂O:H₂O=6:4 (0.6C₀=33.2 M), (d) at D₂O:H₂O=4:6 (0.4C₀=22.1 M), and (e) at D₂O:H₂O=2:8 (0.2C₀=11.1 M).

In the case of light water (A), the vibrationally coupled optical modes are the ninth optical mode (k₉=9k₀=3400 cm⁻¹) in (a) to (d) and the eleventh optical mode (k₁₁=11k₀=3400 cm⁻¹) in (e), and in the case of heavy water (B), the vibrationally coupled optical mode are the seventh optical mode (k₇=7k₀=2500 cm⁻¹) in (a) to (d) and the eighth optical mode (k₈=8k₀=2500 cm⁻¹).

As apparent from the infrared transmission spectra of FIGS. 12(A) and 12(B), both the light water shown in FIG. 12(A) and the heavy water shown in FIG. 12(B) show that as the concentration decreases, the peak intervals between the P₋ state and the P₊ state, that is, the Rabi splitting energy:

ℏΩ_{R}

gradually decreases.

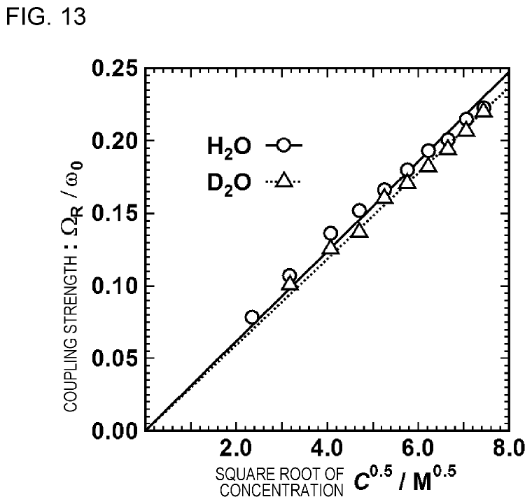

A relation between a coupling strength Ω_{R}/ω₀ and a concentration of light water and heavy water will be discussed with reference to FIG. 13. Referring to the theoretical formula in (Expression 1), Rabi splitting energy

ℏΩ_{R}

is anticipated to be proportional to the square root of the concentration: C. When a coupling strength: Ω_{R}/ω₀ is used in place of Rabi splitting energy:

ℏΩ_{R}

the theoretical anticipation is expressed as Ω_{R}/ω₀∝C^{0.5}. Concentration dependence of a coupling strength Ω_{R}/ω₀ illustrated in FIG. 13 is for examining whether or not the expression is experimentally reasonable. A circle and a triangle are respectively experimental plots of light water and heavy water, and solid lines and dotted lines are theoretical lines assuming a square root law of light water and heavy water, respectively.

The experimental plots for both light water and heavy water are well placed on the theoretical line, and it can be seen that the square root law is established in the relation between the coupling strength: Ω_{R}/ω₀ and the concentration: C for both light water and heavy water as predicted by theory. Therefore, it can be concluded that the method of the present invention realizes the phenomenon of vibrational coupling for both light water and heavy water. An important finding that FIG. 13 reveals is that both light water and heavy water reach an ultra strong coupling state with a coupling strength of Ω_{R}/ω₀≥0.1 at a concentration of C≥9 M, that is, light water and heavy water becomes ultra strong coupling water from a low concentration of about 6 times dilution. It has been confirmed that the ultra strong coupling water can be achieved not only in the Fabry-Pérot cavity presented in this example but also in other optical confinement structures.

### Example 2

In this example, a relation between the Rabi splitting energy of light water (H₂O) and heavy water (D₂O) under vibrational ultra strong coupling:

ℏΩ_{R}

and an optical mode number will be discussed. The point of this example is that light water and heavy water under super strong coupling, that is, ultra strong coupling water has, regardless of the optical mode number and the number of optical modes used for vibrational coupling, a constant value of Rabi splitting energy:

ℏΩ_{R}

In other words, it is possible to select an optical mode from a wide range of options and generate ultra strong coupling water. Details of this example will be described below.

The experimental procedure is the same as in [Example 1]. In this example, optical modes having greatly different optical mode intervals were generated by widely modulating the cavity length: t of the Fabry-Pérot cavity. These optical modes were vibrationally coupled under resonance conditions with the vibrational mode of OH stretching of light water (ω₀=3400 cm⁻¹) and the vibrational mode of OD stretching of heavy water (ω₀=2500 cm⁻¹), respectively. In the experiment, pure light water (concentration: 55.5 M, M=mol·L⁻¹) and pure heavy water (concentration: 55.3 M) were used.

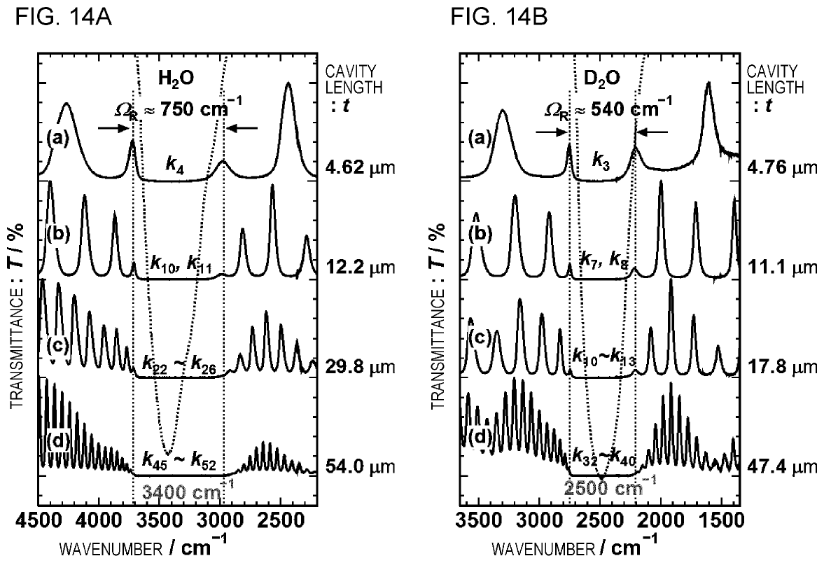

FIGS. 14(A) and 14(B) each illustrate the optical mode dependence of infrared transmission spectra of light water and heavy water under ultra strong coupling, respectively. In the case of light water FIG. 14(A), the cavity length: t (optical mode number: i) increases from top to bottom. Specifically, (a) is that at t=4.62 μm (i=4), (b) at t=12.3 μm (i=10, 11), (c) at t=29.8 μm (i=22 to 26), and (d) at t=54.0 μm (i=45 to 52). In the case of heavy water FIG. 14(B), the cavity length: t (optical mode number: i) also increases from top to bottom, as expected. Specifically, (a) is that at t=4.76 μm (i=3), (b) at t=11.1 μm (i=7, 8), (c) at t=17.8 μm (i=10 to 13), and (d) at t=47.4 μm (i=32 to 40). In the case of light water FIG. 14(A), the ratio of the number of optical modes to the number of vibrational modes is 1:1 in (a), 2:1 in (b), 5:1 in (c), and 8:1 in (d). In the case of heavy water FIG. 14(B), the ratio of the number of optical modes to the number of vibrational modes is 1:1 in (a), 2:1 in (b), and 4:1 in (c), and 9:1 in (d), respectively. In general, although coupling of one optical mode and one vibrational mode is the basis of vibrational coupling as shown in (a) of FIG. 14(A) and (a) of FIG. 14(B), vibrational coupling in which the ratio of the number of optical modes to the number of vibrational modes exceeds 1 is also possible as shown in (b) to (d) of FIG. 14(A) and (b) to (d) of FIG. 14(B). In the case of light water FIG. 14(A) and the case of heavy water FIG. 14(B), their Rabi splitting energy:

ℏΩO_{R}

takes a constant value regardless of the cavity length: t (optical mode number), and Ω_{R}≈750 cm⁻¹ for light water and Ω_{R}≈540 cm⁻¹ for heavy water, respectively.

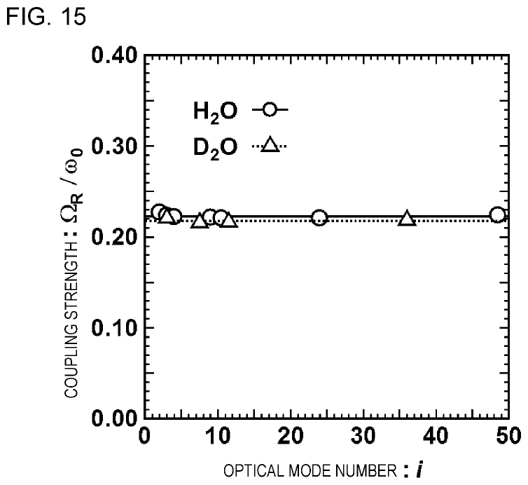

FIG. 15 illustrates a relation between a coupling strength Ω_{R}/ω₀ of light water and heavy water and an optical mode number. Circular marks and triangular marks are respectively experimental plots of light water and heavy water, and a solid line and a dotted line are fitting curves (horizontal lines) of light water and heavy water, respectively. For both light water and heavy water, at least in a range of the optical mode number of 1≤i≤50, the coupling strength Ω_{R}/ω₀ takes a constant value at Ω_{R}/ω₀≈0.22, regardless of an optical mode number i. Further, as described above, in both light water and heavy water, the coupling strength Ω_{R}/ω₀ does not depend on the number of modes of the optical mode coupled to the vibrational mode. From the above results, it is possible to select an optical mode from a wide range of options when generating ultra strong coupling water.

### Example 3

In this example, theoretical prediction of chemical reaction promotion by light water (H₂O) or heavy water (D₂O) in an ultra strong coupling state (0.1≤Ω_{R}/ω₀≤1.0), that is, ultra strong coupling water will be shown. The point of this example is that when ultra strong coupling water is used, a reaction acceleration of 50 to 10 million times can be expected in a typical chemical reaction (activation energy: E₀=0.5 to 2.0 eV).

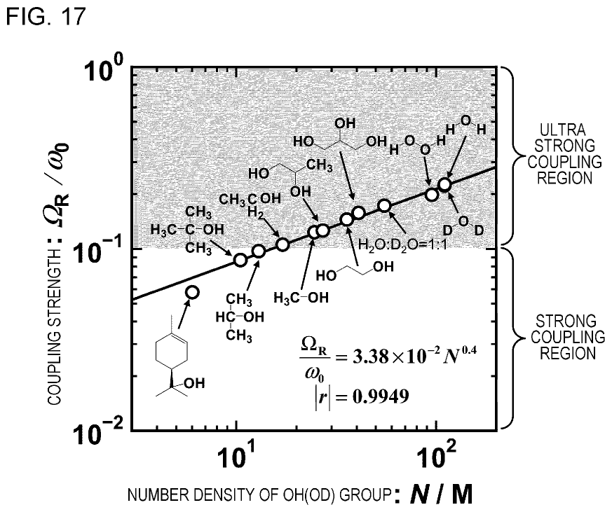

FIG. 17 illustrates a relation between a relative reaction rate constant expected from (Expression 18): κ₋/κ₀ (κ₋: reaction rate constant of vibrational coupling system, κ₀: reaction rate constant of original system) and activation energy: E₀. Here, numerical calculation was conducted using the reaction temperature: T being T=300 K (room temperature) and the coupling strength: Ω_{R}/ω₀ being Ω_{R}/ω₀=0.222, which is a value of pure light water or heavy water. In addition, since this value is in the ultra strong coupling region (0.1≤Ω_{R}/ω₀≤1.0), significant chemical reaction promotion can be expected. Actual evaluation with specific numerical values is provided as follows: The activation energy of a typical chemical reaction: E₀ is in the range of E₀=0.5 eV (48.2 kJ·mol⁻¹) to E₀=2.0 eV (193 kJ·mol⁻¹), for example. Thus, when evaluation is performed with these values as the lower limit and the upper limit, the relative reaction rate constants: κ₋/κ₀ of κ₋/κ₀≈50 and κ₋/κ₀≈10⁷ are obtained, respectively. That is, it can be theoretically predicted that a remarkable reaction acceleration of 50 to 10 million times can be obtained when using ultra strong coupling water as compared with the case using normal water. Moreover, when converted to temperature using (Expression 20), it is expected that a chemical reaction that requires 380 K (107° C.) for normal water can be performed at 300 K (room temperature) for ultra strong coupling water. That is, since the boiling point of water is 100° C. under atmospheric pressure, a solution reaction that cannot normally be performed because water boils can proceed as a solution reaction at room temperature under atmospheric pressure in a case where ultra strong coupling water is used.

In general, the majority of chemical reactions are called aqueous solution reactions. In various chemical reactions in organic, inorganic, biochemistry, electrochemistry including hydrolysis reaction, hydration reaction, and water decomposition reaction, water serves as a reactant source material and a reaction solvent. In view of this, it can be said that the industrial utility value of ultra strong coupling water is very high, and in particular, has the potential to renew the industry in the chemical field. Furthermore, as described in [Example 4] in the next section, this remarkable reaction promotion is not limited to water but is an effect common to matters having an OH (OD) group. Considering that OH (OD) group-containing matters, such as alcohols and hydrogen peroxide water, have a wide range of industrial applications, OH (OD) group-containing matters in an ultra strong coupling state other than the ultra strong coupling water are also of great industrial utility value.

### Example 4

In this example, the results of an experimental evaluation of the relation between the coupling strength of a matter having an OH (OD) group Ω_{R}/ω₀ and the number density of the OH (OD) group will be described. The point of this example is that a matter having an OH (OD) group exhibits a vibrational strong coupling state from a very low concentration (0.0467 mol·L⁻¹) and further reaches a vibrational ultra strong coupling state at a practical concentration (15.1 mol·L⁻¹), proving that the OH (OD) group-containing matter has high industrial utility value as a vibrational strong coupling and vibrational ultra strong coupling matter.

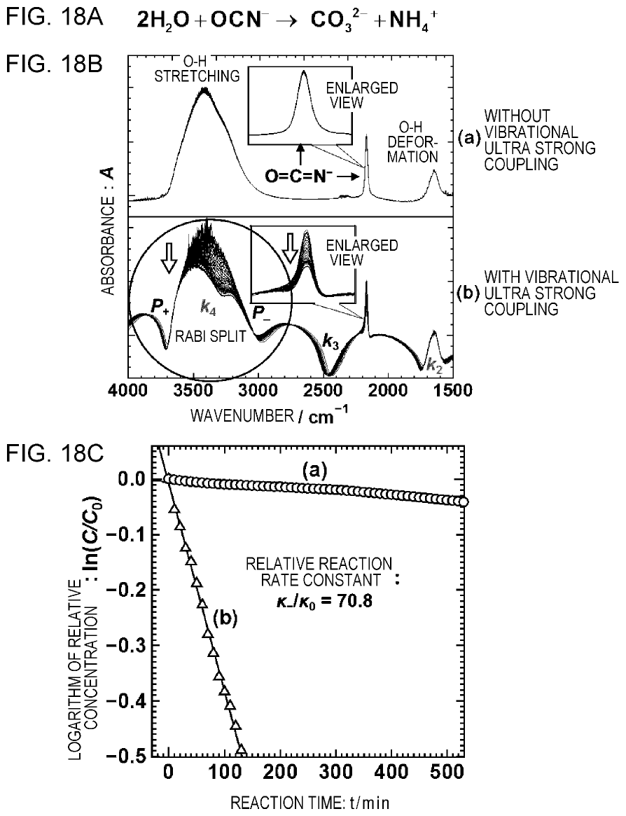

FIGS. 18(A) to 18(C) represent a relation between a coupling strength Ω_{R}/ω₀ of a matter having an OH (OD) group and a number density of the OH (OD) group. The experimental method is the same as in [Example 1] to [Example 2], in which the target matter is introduced into a Fabry-Pérot cavity that satisfies the resonance condition for the OH (OD) group to resonate, and from the infrared transmission spectrum obtained by an FT-IR instrument, Rabi splitting frequency: Ω_{R} and OH (OD) stretching frequency: ω₀ were measured. It should be noted that the number density of OH (OD) vibration: N is defined by the following formula, N: [number density (mol·L⁻¹)]=[density (g·L⁻¹)]/[molar mass (g·mol⁻¹)]×[number of OH (OD) groups in one molecule]. That is, the number density: N is the number of vibrational modes per unit molar concentration. For example, in the case of water (H₂O), since the density is 999.97 g·L⁻¹, the molar mass is 18.015 g·mol⁻¹, and the number of OH groups in one molecule is 2, the number density is 111.02 mol·L⁻¹.

The most remarkable feature of FIGS. 18(A) to 18(C) is that even between different materials, an exponential law (0.4 power law) similar to the square root law (0.5 power law) shown in [Example 1] holds between the coupling strength: Ω_{R}/ω₀ and the number density: N. That is, when the regression line is obtained by the method of least squares, the empirical formula Ω_{R}/ω₀=3.38×10⁻²×N^{0.4} of the coupling strength: Ω_{R}/ω₀ and the number density: N is obtained with a high correlation represented by correlation strength: |r|=0.9949. Considering the theoretical formula of (Expression 1), this result is attributed to the fact that even different materials have the same transition dipole moment: d of the OH (OD) vibration. This means that when using the vibrational coupling, a matter having an OH (OD) group produces an effect equivalent to that of ultra strong coupling water depending on the number density. For example, in a case where a matter having an OH (OD) group is used as the solvent for a chemical reaction, the same effect of promoting the reaction as that obtained when ultra strong coupling water is used as the solvent can be obtained.

Taking a close look at FIGS. 18(A) to (C), the coupling strength Ω_{R}/ω₀ tends to increase as the molar mass (molecular weight) decreases and as the number of OH (OD) vibrations per molecule increases. The coupling strength Ω_{R}/ω₀ is listed in descending order as follows: light water (H₂O) (Ω_{R}/ω₀=0.225), heavy water (D₂O) (ω_{R}/ω₀=0.222), hydrogen peroxide (H₂O₂) (Ω_{R}/ω₀=0.200), 1:1 mixture of light water and heavy water (Ω_{R}/ω₀=0.172), glycerin (Ω_{R}/ω₀=0.157), ethylene glycol (Ω_{R}/ω₀=0.144), propylene glycol (ω_{R}/ω₀=0.126), methanol (ω_{R}/ω₀=0.123), ethanol (Ω_{R}/ω₀=0.105), isopropyl alcohol (Ω_{R}/ω₀=0.0968), t-butyl alcohol (Ω_{R}/ω₀=0.0865), and terpineol (Ω_{R}/ω₀=0.0575). Therefore, referring to (Expression 4), the above-mentioned light water to ethanol are ultra strong coupling matters (0.1≤Ω_{R}/ω₀≤1.0), and referring to (Expression 3), from isopropyl alcohol to terpineol are strong coupling matters (0.01≤Ω_{R}/ω₀<0.1). In particular, in the case of light water (H₂O), heavy water (D₂O), and hydrogen peroxide (H₂O₂), the molecular weight is small and there are two OH (OD) vibrations per molecule, so that a large coupling strength Ω_{R}/ω₀≥0.2 is obtained.

Referring to the above empirical Expression: Ω_{R}/ω₀=3.38×10⁻²×N^{0.4}, the lower limit of the number density: N of the OH (OD)-containing matter as an ultra strong coupling matter is N≈15.1 mol·L⁻¹ and the lower limit of the number density: N of OH (OD)-containing matter as a strong coupling matter is N≈0.0467 mol·L⁻¹. Therefore, in an OH (OD)-containing matter, strong coupling is exhibited from a very low concentration, and it is possible to create an ultra strong coupling state at a practical concentration as experimentally shown in FIGS. 18(A) to 18(C). This is a great advantage in terms of industrial use of the vibrational coupling by the OH (OD)-containing matter. For example, OH (OD)-containing matters are frequently used as chemical reaction solvents such as aqueous solutions and alcohol solutions. Therefore, when the chemical reaction is promoted by vibrational coupling, the coupling strength Ω_{R}/ω₀ can be maintained high throughout the reaction by using the OH (OD)-containing matter. This is an advantage that cannot be obtained with other materials. The reason why these OH (OD)-containing matters have a large coupling strength is that the OH (OD) vibration has a huge transition dipole moment of d=0.420 D (D: debye).

Furthermore, the above empirical expression Ω_{R}/ω₀=3.38×10⁻²×N^{0.4} also holds true for a mixture of matters having an OH (OD) group. Although the OH (OD) group-containing matter that is liquid at room temperature has been taken up in FIGS. 18(A) to 18(C), the above empirical formula Ω_{R}/ω₀=3.38×10⁻²×N^{0.4} also holds for a solid OH (OD) group-containing matter. For example, polyvinyl alcohol ((—CH₂CHOH—)ₙ), which is a polymer solid, has a coupling strength of Ω_{R}/ω₀=0.140 and a number density of approximately 30.0 mol·L⁻¹ according to actual measurements, which is well-placed on the empirical expression Ω_{R}/ω₀=3.38×10⁻²×N^{0.4}. Accordingly, even if the matter having an OH (OD) group is a solid, its aqueous solution or alcohol solution behaves as a solvent having a strong coupling or an ultra strong coupling. In summary, matters containing an OH (OD) group, whether liquid or solid, whether pure substances or and mixtures, can fully exert their effects as strong or ultra strong coupling matters.

### Example 5

In this example, it is proven that the reaction rate constant can be significantly increased by using a vibrational coupling chemical reaction device produced by the means described in [Description of Production Method] with respect to hydrolysis reaction to produce carbonate ion (CO³⁻) and ammonium ion (NH₄⁺) from water (H₂O) and cyanate ion (O═C═N⁻), the chemical reaction being illustrated in FIG. 18(A). The point of this example is that the use of ultra strong coupling water according to the present invention can decompose cyanate ions into carbonate ions and ammonium ions with approximately 70 times the reaction acceleration.

Experimental conditions are as follows. All experiments were performed at room temperature (T=300K), and potassium cyanate (KOCN) was dissolved in water to obtain 2.00-M cyanate ion and 50.9-M water. Water is in large excess and acts as a reaction solvent with respect to cyanate ions. The reaction device is as follows. First, for the absence of a vibrational ultra strong coupling, an experiment was performed in a non-resonant structure without an optical mode by use of a chemical reaction device without a mirror plane. On the other hand, for the presence of a vibrational strong coupling, an experiment was performed in a resonant structure with an optical mode by use of a chemical reaction device with a mirror plane.

Specifically, a zinc selenide (ZnSe) substrate having a property of transmitting infrared rays was used as an infrared window of the chemical reaction device without a mirror plane. In order to prevent the reaction solution from coming into direct contact with the ZnSe window, a silicon dioxide (SiO₂) film having a thickness of approximately 100 nm was formed as a protective film using a solution process method. On the other hand, the central structure of the chemical reaction device with a mirror plane was a Fabry-Pérot cavity, and similarly a ZnSe substrate was used as an infrared window. On the ZnSe window, a gold (Au) film with a thickness of approximately 10 nm was formed by sputtering method as a mirror plane, and then in order to prevent the reaction solution from coming into direct contact with the ZnSe window, a silicon dioxide (SiO₂) film having a thickness of approximately 100 nm was formed using a solution process method as a protective film.

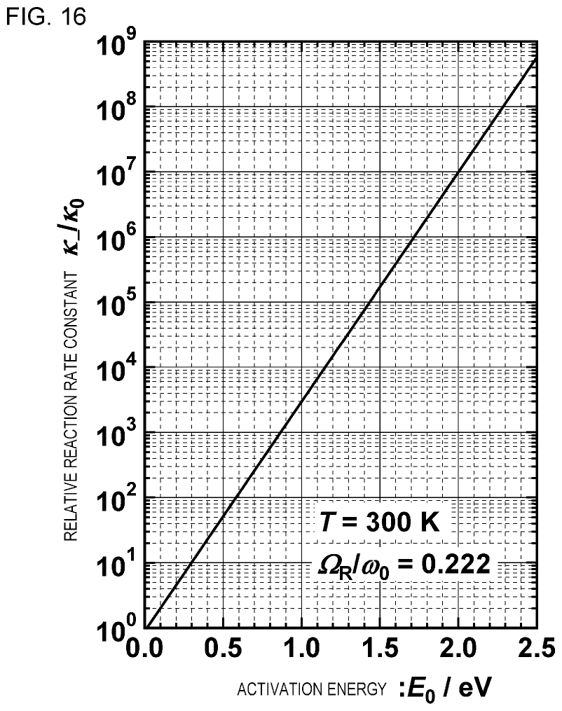

In the chemical reaction device with a mirror plane, an optical mode of a Fabry-Pérot cavity (k₄=4k₀=3400 cm⁻¹) was vibrationally coupled with a vibrational mode of OH stretching of water (ω₀=3400 cm⁻¹) by strictly adjusting a cavity length. At this time, the coupling strength was Ω_{R}/ω₀=0.214. Accordingly, the vibrational coupling belongs to the ultra strong coupling region (0.1≤Ω_{R}/ω₀≤1.0) expressed by (Expression 4). At this time, the water was ultra strong coupling water and was very close to pure ultra strong coupling water (concentration: 55.5 M, Ω_{R}/ω₀=0.225). Moreover, since water was a largely excessive solvent, the coupling strength did not decrease during the reaction and maintained high. The Q value was Q=19.4 in the vicinity of the wave number 2500 cm⁻¹. Since the activation energy of the chemical reaction in (A) of FIG. 18 is Eₐ₀=0.6±0.1 eV, a relative reaction rate constant is predicted to be in a range of 45<κ₋/κ₀<200 using (Expression 17) or (Expression 18) (refer to FIG. 16).

The analysis method of the experimental data is as follows. In order to determine a reaction rate constant, infrared absorption spectra were measured at regular time intervals with an FT-IR instrument. A temporal change in concentration was determined from a temporal change in absorbance of the infrared absorption band of the O═C═N stretching vibration of cyanate ion. When estimating a reaction rate constant, since water was largely excessive with respect to cyanate ion, a pseudo first order reaction was assumed, and analysis was performed by fitting to the reaction rate expression: In C=−κt+ln C₀ (C: concentration, C₀: initial concentration, κ: reaction rate constant, and t: time). A ratio: κ₋/κ₀ of a reaction rate constant with a vibrational ultra strong coupling: κ₋ to a reaction rate constant without a vibrational ultra strong coupling: κ₀ was derived as a relative reaction rate.

Experimental results are as follows. FIG. 18(B) illustrates temporal changes of infrared absorption spectra in the chemical reaction illustrated in FIG. 18(A), and (a) represents a spectral change without a vibrational ultra strong coupling and (b) represents a spectral change with a vibrational ultra strong coupling (OH stretching vibration). In (a), normal infrared absorption spectra was observed since optical modes do not exist, whereas it was observed in (b) as indicated in a circle that the vibrational mode of OH stretching of water was vibrationally coupled with the fourth optical mode in the vicinity of the wave number of 3400 cm⁻¹, resulting in Rabi-splitting into an upper branch P₊ and a lower branch P₋ in addition to optical modes of the Fabry-Pérot cavity (k₂, k₃). The enlarged view in FIG. 18(B) shows the temporal change of O═C═N stretching vibration of cyanate ion, in which in the case of (a) without a vibrational ultra strong coupling, the absorbance was hardly decreased during the reaction time whereas in the case of (b) with vibrational ultra strong coupling (OH stretching vibration), the absorbance was decreased by half during the reaction time. On the other hand, in the case of (b) with a vibrational ultra strong coupling (OH stretching vibration), water was excessively large, and thus the coupling strength Ω_{R}/ω₀ was substantially constant during the reaction time.

FIG. 18(C) illustrates relations between the logarithm of relative concentration and reaction time determined from temporal changes in absorbance shown in FIG. 18(B), and (a) represents that in the case without a vibrational ultra strong coupling (plotted with circle marks) and (b) represents that in the case with a vibrational ultra strong coupling (plotted with triangle marks). Reaction rate constants are determined from slopes of respective fitting lines in (a) and (b) as follows: κ₀=8.56×10⁻⁷ s⁻¹ in the case without a vibrational ultra strong coupling and κ₋=6.13×10⁻⁵ s⁻¹ in the case where a vibrational ultra strong coupling (OH stretching vibration). A relative reaction rate constant determined from these values was κ₋/κ₀=70.8. As such, chemical reaction promotion by the vibrational ultra strong coupling of the OH stretching vibration of water is actually observed, and the relative reaction rate constant is within the range (45<κ₋/κ₀<200) as predicted by use of (Expression 17) or (Expression 18).

It is thus proven from the experimental results described above that a purpose of optical electrical-field confinement is compatible with a purpose of performing a chemical reaction in a chemical reaction device produced by the method described in Description of Production Method, a vibrational coupling promotes a chemical reaction as predicted by use of (Expression 17) or (Expression 18), and the chemical reaction device produced by the method described in Description of Production Method can actually produce a target chemical substance.

### Example 6

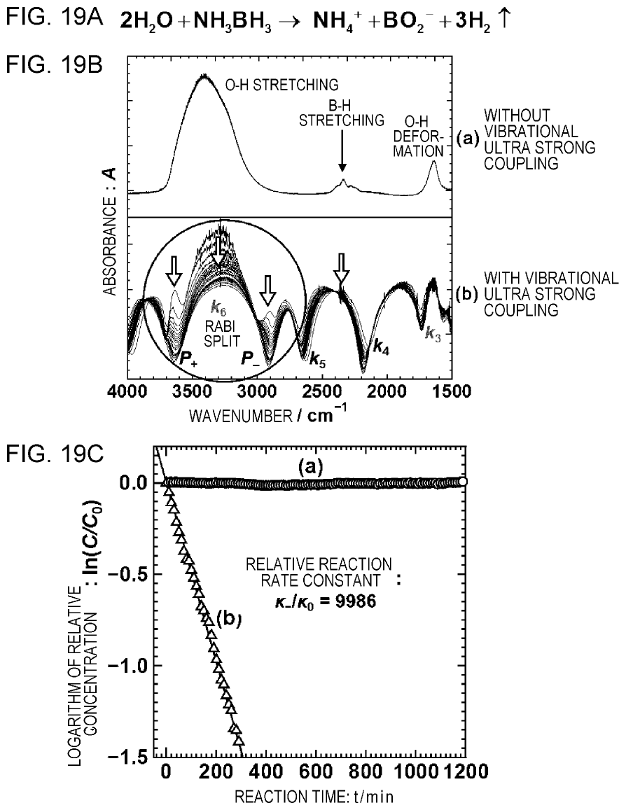

In this example, it is proven that the reaction rate constant can be significantly increased by using a vibrational coupling chemical reaction device produced by the means described in [Description of Production Method] with respect to hydrolysis reaction to produce ammonium ion (NH₄⁺), metaborate ion (BO₂⁻), and hydrogen (H₂) from water (H₂O) and ammonia borane (NH₃BH₃), the chemical reaction being illustrated in FIG. 19(A). The point of this example is that with use of ultra strong coupling water of the present invention, hydrogen can be extracted from ammonia borane by hydrolysis with approximately ten thousand times the reaction acceleration.

Experimental conditions are as follows. All experiments were performed at room temperature (T=300K), and a reaction solution was obtained by dissolving ammonia borane in water. The concentration of the reaction solution was 52.3 M for water and 2.00 M for ammonia borane. Therefore, water is in large excess with respect to ammonia borane, and water also acts as a reaction solvent. The reaction device is the same as that described in [Example 5]. In the chemical reaction device with a mirror plane, an optical mode of a Fabry-Pérot cavity (k₆=6k₀=3400 cm⁻¹) was vibrationally coupled with a vibrational mode of OH stretching of water (ω₀=3400 cm⁻¹) by strictly adjusting a cavity length. At this time, the coupling strength was Ω_{R}/ω₀=0.218. Accordingly, the vibrational coupling belongs to the ultra strong coupling (0.1≤Ω_{R}/ω₀≤1.0) expressed by (Expression 4). At this time, the water was ultra strong coupling water and was very close to pure ultra strong coupling water (concentration: 55.5 M, Ω_{R}/ω₀=0.225). Moreover, since water was a largely excessive solvent, the coupling strength did not decrease during the reaction and maintained high. The Q value was Q=23.3 in the vicinity of the wave number 2400 cm⁻¹. Since activation energy of the chemical reaction in (A) of FIG. 19 is Eₐ₀=1.1±0.1 eV, a relative reaction rate constant is predicted to be in a range of 7000<vκ₋/κ₀<20000 using (Expression 17) or (Expression 18) (refer to FIG. 16).

The analysis method of the experimental data is as follows. In order to determine a reaction rate constant, infrared absorption spectra were measured at regular time intervals with an FT-IR instrument. Without a vibrational ultra strong coupling, a temporal change in concentration was directly determined from a temporal change in absorbance of the infrared absorption band for the BH stretching vibration of ammonia borane. With a vibrational ultra strong coupling, a temporal change in concentration was indirectly determined from a temporal change in absorbance of an optical mode accompanying with substitution of the medium of the Fabry-Pérot cavity from bulk liquid water (refractive index: n=1.31) to minute gaseous hydrogen (refractive index: n=1.00), not the temporal change in absorbance of the infrared absorption band. This is because, in the case without a vibrational ultra strong coupling, hydrogen is hardly generated, but in the case with a vibrational ultra strong coupling, a large amount of hydrogen is generated due to the reaction promotion by the ultra strong coupling water. When estimating a reaction rate constant, since water was largely excessive with respect to ammonia borane, a pseudo first order reaction was assumed, and analysis was performed by fitting to the reaction rate expression: In C=−κt+ln C₀ (C: concentration, C₀: initial concentration, κ: reaction rate constant, and t: time). A ratio: κ₋/κ₀ of a reaction rate constant with a vibrational ultra strong coupling: κ₋ to a reaction rate constant without a vibrational ultra strong coupling: κ₀ was derived as a relative reaction rate.

Experimental results are as follows. FIG. 19(B) illustrates temporal changes of infrared absorption spectra in the chemical reaction illustrated in FIG. 19(A), and (a) represents a spectral change without a vibrational ultra strong coupling and (b) represents a spectral change with a vibrational ultra strong coupling (OH stretching vibration). In (a), normal infrared absorption spectra was observed since any optical modes do not exist, whereas it was observed in (b) as indicated in a circle that the vibrational mode of OH stretching of water was vibrationally coupled with the fourth optical mode of the Fabry-Pérot cavity in the vicinity of the wave number of 3400 cm⁻¹, resulting in Rabi-splitting into an upper branch P₊ and a lower branch P₋ in addition to optical modes of the Fabry-Pérot cavity (k₃, k₄, k₅). In the case of (a) without a vibrational ultra strong coupling, the absorbance of BH stretching vibration was hardly decreased during the reaction time of 20 hours whereas in the case of (b) with vibrational ultra strong coupling (OH stretching vibration), in the Fabry-Pérot cavity, water was completely replaced to hydrogen in 5 hours.

FIG. 19(C) illustrates relations between the logarithm of relative concentration and reaction time determined from temporal changes in absorbance shown in FIG. 19(B), and (a) represents that in the case without a vibrational ultra strong coupling (plotted with circle marks) and (b) represents that in the case with a vibrational ultra strong coupling (plotted with triangle marks). Reaction rate constants are determined from slopes of respective fitting lines in (a) and (b) as follows: κ₀=1.289×10⁻⁸ s⁻¹ in the case without a vibrational ultra strong coupling, which is almost same as the literature value. On the other hand, κ₋=1.287×10⁻⁴ s⁻¹ in the case of vibrational ultra strong coupling (OH stretching vibration). A relative reaction rate constant determined from these values was κ₋/κ₀=9987. As such, remarkable chemical reaction promotion by the vibrational ultra strong coupling of the OH stretching vibration of water is actually observed, and the relative reaction rate constant is within the range (7000<κ₋/κ₀<20000) as predicted by use of (Expression 17) or (Expression 18).

It is thus proven from the experimental results described above that a purpose of optical electrical-field confinement is compatible with a purpose of performing a chemical reaction in a chemical reaction device produced by the method described in Description of Production Method, a vibrational coupling promotes a chemical reaction as predicted by use of (Expression 17) or (Expression 18), and the chemical reaction device produced by the method described in Description of Production Method can actually produce a target chemical substance.

### Example 7

In this example, with respect to light water (H₂O) and heavy water (D₂O) under vibrational ultra strong coupling, the results of comparison of the coupling strength Ω_{R}/ω₀ of the liquid (water) and the solid (ice) will be described. Hereinafter, as the water under an ultra strong coupling state has been referred to as ultra strong coupling water, the ice under an ultra strong coupling state is appropriately referred to as an ultra strong coupling ice.

The point of this example embodiment is that, when an optical mode of a cavity and an OH (OD) vibrational mode of a water molecule are resonantly coupled, the ice also exhibits an ultra strong coupling state like liquid water, and the coupling strength Ω_{R}/ω₀ of the ultra strong coupling ice is Ω_{R}/ω₀≈0.31 in the case of light water (H₂O), and Ω_{R}/ω₀≈0.33 in the case of heavy water (D₂O), which is approximately 1.5 times higher than the coupling strength of the ultra strong coupling water Ω_{R}/ω₀≈0.22 (both light and heavy water). It should be noted that the value of the coupling strength Ω_{R}/ω₀ of the ultra strong coupling ice is the highest among the matters within the range studied by the inventors. That is, it means that the ultra strong coupling ice promotes the chemical reaction more than the ultra strong coupling water.

The experimental procedure is the same as [Example 1] to [Example 2] and [Example 4] to [Example 6]. However, as an infrared window of the Fabry-Pérot cavity, a sapphire (Al₂O₃) substrate was used in combination with a zinc selenide (ZnSe) substrate. In addition, the temperature control for freezing water into ice was performed by circulating the refrigerant supplied from the thermostatic device to the enclosure of the Fabry-Pérot cavity, and by feeding back the temperature measured by a thermocouple in contact with the infrared window. The measurement was performed between room temperature and the freezing point in the case of water and between the melting point and −10° C. in the case of ice. The vibrational coupling was applied to OH stretching vibration in light water (H₂O) and OD stretching vibration in heavy water (D₂O).

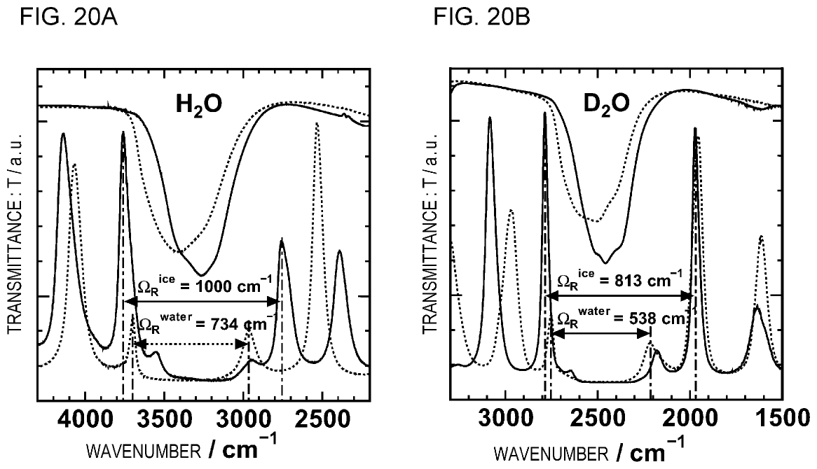

FIGS. 20(A) and 20(B) show a comparison of infrared transmission spectra of ultra strong coupling water and ultra strong coupling ice. FIG. 20(A) represents that in the case of pure light water (H₂O) and FIG. 20(B) represents that in the case of pure heavy water (D₂O). First, in the case of FIG. 20(A), the Rabi splitting energy: Ω_{R} is Ω_{R}=734 cm⁻¹ in H₂O water, whereas Ω_{R}=1000 cm⁻¹ in H₂O ice. When these values are converted into coupling strength Ω_{R}/ω₀, Ω_{R}/ω₀≈0.22 is obtained for H₂O water, and Ω_{R}/ω₀≈0.31 for H₂O ice. Next, in the case of FIG. 20(B), Rabi splitting energy Ω_{R} is Ω_{R}=538 cm⁻¹ in D₂O water, whereas Ω_{R}=813 cm⁻¹ in D₂O ice, and when converted into coupling strength Ω_{R}/ω₀, Ω_{R}/ω₀≈0.22 is obtained for D₂O water, and Ω_{R}/ω₀≈0.33 for D₂O ice. That is, when changing from water to ice, the coupling strength Ω_{R}/ω₀ increases by a rate of approximately 36% for light water (H₂O) and approximately 50% for heavy water (D₂O).

The point that should be noted is that the value of the coupling strength of heavy water (D₂O) ice Ω_{R}/ω₀≈0.33 is the largest among the matters in the range examined by the inventor, and the value of the coupling strength of light water (H₂O) ice Ω_{R}/ω₀≈0.31 is the second largest in the matters. This increase of the coupling strength Ω_{R}/Ω₀ accompanying the change from water to ice can be interpreted as follows. That is, with the change from water to ice, the concentration decreases by approximately 8% from 55.41 M to 50.89 M for light water (H₂O) and from 55.20 M to 50.80 M for heavy water (D₂O), respectively. This concentration reduction reduces the coupling strength Ω_{R}/ω₀ by approximately 4% when converted from the square root law (Ω_{R}/ω₀∝C^{0.5}) derived from (Expression 1). However, along with the change from water to ice, according to separate actual measurements, the absorbance of OH (OD) vibration increases by approximately 40% for light water (H₂O) and approximately 55% for heavy water (D₂O). This increase in absorbance results from the enhancement of hydrogen bonds between water molecules. Specifically, the number of adjacent water molecules (coordination number) hydrogen-bonded to a certain water molecule can take a number between 0 and 4 for water, while the average value for ice is close to 4. This is because ice has stronger hydrogen bonds than water. Here, the absorbance is proportional to the transition dipole moment: d, and from (Expression 1), the coupling strength: Ω_{R}/ω₀ is proportional to the transition dipole moment: d. Thus, the above-described increase in absorbance directly leads to an increase in coupling strength: Ω_{R}/ω₀ by approximately 40% for light water (H₂O) and approximately 55% for heavy water (D₂O). Therefore, the increase in absorbance accompanying the change from water to ice is more than enough to cancel the decrease in concentration, and after all, when subtracted, the ultra strong coupling ice has a stronger coupling strength Ω_{R}/ω₀ that is approximately 36% greater for light water (H₂O) and approximately 50% greater for heavy water (D₂O) than ultra strong coupling water.

As discussed above, it is thus proven that, according to the method of the present invention, by virtue of vibrational coupling, ice can be brought into an ultra strong coupling state as well as liquid water, and the coupling strength Ω_{R}/ω₀ of ultra strong coupling ice is Ω_{R}/ω₀≈0.31 in the case of light water (H₂O), and Ω_{R}/ω₀ 0.33 in the case of heavy water (D₂O), which is the highest among the matters.

### Example 8

In this example, a relation between a frequency of a polariton state and a coupling strength Ω_{R}/ω₀ will be described for liquid water and solid ice of light water (H₂O) and heavy water (D₂O). The point of this example is that it is possible to freely create water and ice having various coupling strengths Ω_{R}/ω₀ from strong coupling to ultra strong coupling as well as weak coupling as expected from the theory of vibrational coupling, and in particular, it is possible to realize ultra strong coupling water and ultra strong coupling ice that have a remarkable chemical reaction promoting effect.

The experimental procedure is the same as in [Example 7]. First, the experimental value was obtained by actually measuring a vibrational coupling state with respect to OH stretching vibration and OD stretching vibration for a mixture of light water (H₂O) and heavy water (D₂O). Next, theoretical values were obtained from the relation between the frequencies of the polariton states of the upper branch and the lower branch and the coupling strength Ω_{R}/ω₀ represented by the following theoretical formula (Expression 26).

$${ω}_{\pm } = 1 \pm \frac{1}{2} \frac{{Ω}_{R}}{{ω}_{0}} \qquad ( Expression 26 )$$

As described above, ω_{±} are the frequencies of the polariton states of the upper branch and lower branch, respectively, Ω_{R} is the Rabi splitting energy, and ω₀ is the frequency of a molecule in the original system. It should be noted that (Expression 26) corresponds to (Expression 11) normalized by ω₀. Finally, the above experimental values and theoretical values were compared.

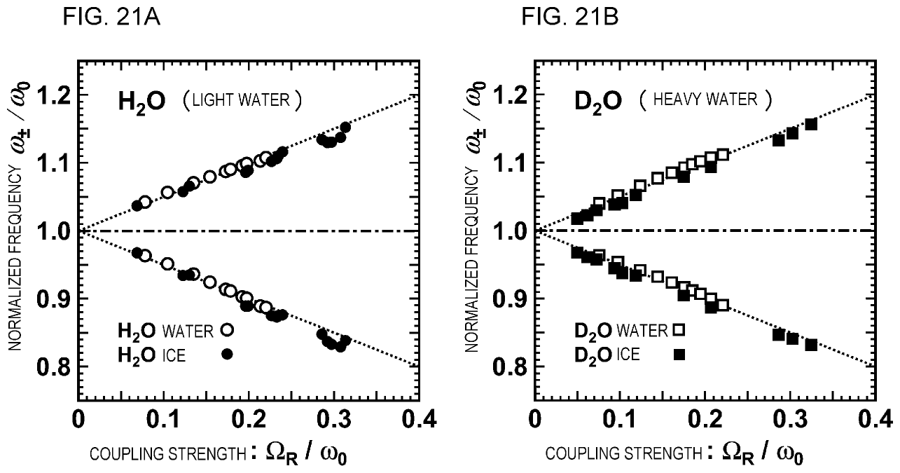

FIGS. 21(A) and 21(B) illustrates the relation between the normalized upper branch and lower branch polariton frequencies ω_{±}/ω₀ and coupling strength Ω_{R}/ω₀. FIG. 21(A) represents that in the case of light water (H₂O) and FIG. 21(B) represents that in the case of heavy water (D₂O). In FIG. 21(A), an open circle indicates an experimental value plot of water of light water (H₂O), and a filled circle indicates an experimental value plot of ice of light water (H₂O). The dotted line is a theoretical line based on (Expression 26). The theoretical line of the upper branch and lower branch polaritons has a y-intercept of 1 and slopes of +0.5 and 0.5, respectively. The experimental value plots for both light water (H₂O) and ice are very well-placed on the theoretical line. This good match proves that both light water (H₂O) water and ice follow the theory of vibrational coupling. This means that when the coupling strength is Ω_{R}/ω₀≥0.1, ultra strong coupling water of light water (H₂O) and ultra strong coupling ice of light water (H₂O) can be realized.

The same result is obtained in FIG. 21(B) illustrating the case of heavy water (D₂O). An open square indicates an experimental value plot of heavy water (D₂O) water, and a filled square indicates an experimental value plot of heavy water (D₂O) ice. The dotted line is a theoretical line based on (Expression 26). Since the experimental value plots for both water and ice of heavy water (D₂O) are well-placed on the theoretical line, it can be seen that the experiment of the present invention follows the theory of vibrational coupling for both water and ice of heavy water (D₂O). In particular, this proves that when the coupling strength is Ω_{R}/ω₀≥0.1, ultra strong coupling water of heavy water (D₂O) and ultra strong coupling ice of heavy water (D₂O) can be realized.

As discussed above, according to the method of the present invention, it is possible to create water and ice having any coupling strength Ω_{R}/ω₀ from strong coupling to ultra strong coupling as well as weak coupling, as expected from the theory of vibrational coupling. In particular, it is proven that ultra strong coupling water and ultra strong coupling ice having a remarkable chemical reaction promoting effect can be realized.

### Example 9

In this example, description will be provided by adding the data of ice to the relation between the coupling strength: Ω_{R}/ω₀ of matters having an OH (OD) group shown in [Example 4] and the number density of the OH (OD) group: N. The point of this example is that pure light water (H₂O) ice and pure heavy water (D₂O) ice have an unusually large coupling strength Ω_{R}/ω₀ among substances having OH (OD) vibration.

The experimental procedure is the same as in [Example 4] and [Example 7]. The number density of pure light water (H₂O) ice is 101.8 M, which is obtained by multiplying the molar concentration of pure light water (H₂O) ice: 50.89 M by the number of OH groups in light water (H₂O): 2. The number density of pure heavy water (D₂O) ice is 101.6 M, which is obtained by multiplying the molar concentration of pure heavy water (D₂O) ice: 50.80 M by the number of OD groups in heavy water (D₂O): 2. The vibrational coupling was applied to OH stretching vibration or OD stretching vibration.

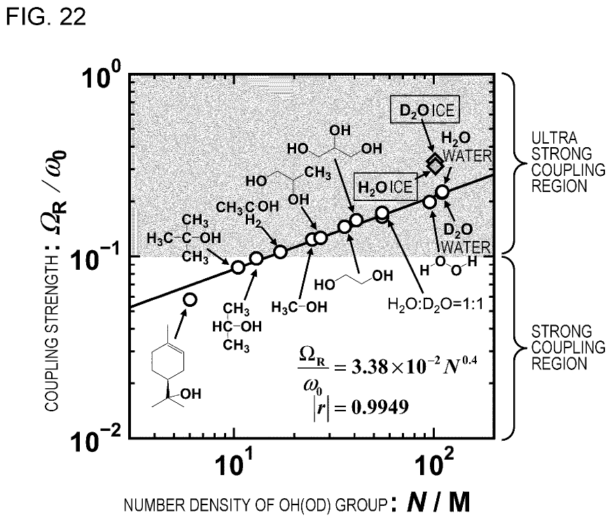

FIG. 22 shows the relation between the coupling strength: Ω_{R}/ω₀ and the number density of OH (OD) groups: N of matters having OH (OD) groups including light water (H₂O) and heavy water (D₂O) ice. As described in [Example 4], in the case of liquid, even between different materials, an exponential law (0.4 power law) similar to the square root law (0.5 power law) shown in [Example 1] holds between the coupling strength: Ω_{R}/ω₀ and the number density: N. However, as indicated by the gray rhombus marks in the figure, solid ice deviates from the above exponential law for both light water (H₂O) and heavy water (D₂O), and has exceptionally high coupling strength Ω_{R}/ω₀. The reason is that, as described in [Example 7], solid ice has a large transition dipole moment: d due to the enhancement of hydrogen couplings, as compared with liquid water. Heavy water (D₂O) ice and light water (H₂O) ice have the first and second coupling strength Ω_{R}/ω₀ in all materials, respectively, and thus, together with liquid-state water of light water (H₂O) and heavy water (D₂O), having the third largest (both have a coupling strength of Ω_{R}/ω₀≈0.22), heavy water (D₂O) ice and light water (H₂O) ice can be said to be the most promising substance for accelerating chemical reactions.

As discussed above, when the method of the present invention is used, it is proved that ultra strong coupling ice has the highest coupling strength Ω_{R}/ω₀ in the matters.

### Example 10

In the example, results of comparing water and ice of light water (H₂O) on the relation between the Rabi splitting energy: Ω_{R} of OH stretching vibration and concentration, and the transition phenomenon of Rabi splitting energy: Ω_{R} of light water (H₂O) under ultra strong coupling will be described. The points of this example are as follows. First, even in the case of light water (H₂O) ice under vibrational coupling, as in the case of light water (H₂O) water under vibrational coupling, an exponential law (0.4 power law) similar to the square root law (0.5 power law) holds between Rabi splitting energy: Ω_{R} (or coupling strength: Ω_{R}/ω₀) and number density: N. On the other hand, unlike light water (H₂O) water under vibrational coupling, in the case of light water (H₂O) ice under vibrational coupling, when the relative concentration is C/C₀=86% (C₀=43.7 mol-dm⁻³), the Rabi splitting energy is transited from Ω_{R}=781 cm⁻¹ to Ω_{R}=932 cm⁻¹. The experimental procedure is the same as in [Example 1] and [Example 7].

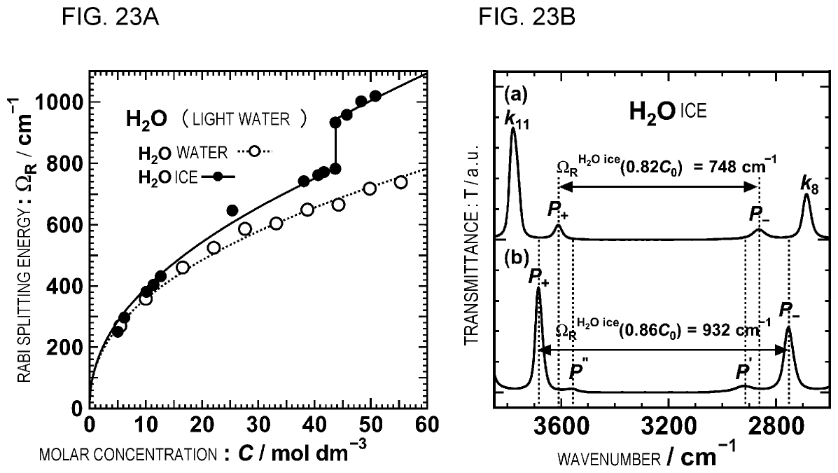

FIG. 23(A) illustrates a comparison of the relation between the Rabi splitting energy: Ω_{R} and concentration: C of OH stretching vibration of water and ice of light water (H₂O) under vibrational coupling. An open circle indicates an experimental value plot for light water (H₂O) water, and a filed circle indicates an experimental value plot for light water (H₂O) ice. The dotted line represents a fitting curve assuming an exponential function in the case of light water (H₂O) water, and the solid line represents an exponential function in the case of light water (H₂O) ice. In light water (H₂O) water under vibrational coupling, an exponential law (0.4 power law) similar to the square root law (0.5 power law) is established between Rabi splitting energy: Ω_{R} and number density: N. A similar exponential law can be seen for light water (H₂O) ice, but at the same concentration, ice under vibrational coupling has a greater Rabi splitting energy: Ω_{R} than water under vibrational coupling. On the other hand, in light water (H₂O) ice, the most noteworthy point is that when the molar concentration is C=43.7 mol·dm⁻³ (relative concentration: C/C₀=86%), the Rabi splitting energy jumps sharply from Ω_{R}=781 cm⁻¹ to Ω_{R}=932 cm⁻¹ and moves from one exponential curve to another. Such a transition phenomenon has never been observed so far, and is the first phenomenon observed on ice under vibrational coupling.

FIG. 23(B) illustrates infrared transmission spectra of light water (H₂O) ice under ultra strong coupling before and after the transition. (a) illustrates that in the case where the relative concentration is C/C₀=82%, that is, before the transition, and (b) illustrates that in the case where the relative concentration is C/C₀=86%, that is, after the transition. When (a) and (b) are compared to each other, two significant differences are seen. The first difference is that Rabi splitting energy: Ω_{R} is greatly different. Specifically, the Rabi splitting energy is greatly increased from Ω_{R}=748 cm⁻¹ to Ω_{R}=932 cm⁻¹ despite a slight concentration difference. The second difference is that in the case of (a) before transition, the Rabi splitting is a normal double splitting (two peaks of P₊ and P⁻), whereas in case of (b) after transition, the Rabi splitting becomes a special quadruple splitting (four peaks of P₊, P″, P′, and P⁻). Quadruple Rabi splitting is a phenomenon that is observed only when Rabi splitting energy Ω_{R} or coupling strength Ω_{R}/ω₀ is extremely large, that is, only in an ultra strong coupling state. The normal double Rabi splitting is a phenomenon in which two polaritons are generated in one optical mode and one vibrational mode, whereas quadruple Rabi splitting is a phenomenon in which six polaritons in three optical modes and one vibrational mode are generated. In the case of light water (H₂O), of the six polaritons, four polaritons appear as four peaks of P₊, P″, P′, and P₋ near the vibrational mode (3250 cm⁻¹) of the original system, and the remaining two polaritons are hidden on the high and low wavenumber sides. Although it is originally a sextuple splitting, it is called quadruple splitting because four peaks are clearly observed in the vicinity of the vibrational mode (3250 cm⁻¹) of the original system. In the case of liquid light water (H₂O), the above-described quadruple splitting is not observed. The reason for this is that even with pure light water (H₂O), the coupling strength is Ω_{R}/ω₀≈0.22, and the coupling strength Ω_{R}/ω₀ does not reach the threshold for the transition phenomenon from double split to quadruple split.

In addition, one of the remarkable features of ultra strong coupling ice of light water (H₂O) is that a transition phenomenon from double split to quadruple split can occur in the vicinity of the transition concentration without changing the concentration. For example, at the same concentration in the vicinity of relative concentration: C/C₀=86%, ultra strong coupling ice with double split and relatively small Rabi splitting energy: Ω_{R}, or ultra strong coupling ice with quadruple split and relatively large Rabi split energy: Ω_{R} can be separately obtained, depending on the water-ice solidification and melting history. That is, by adjusting the concentration and the temperature, it is possible to make two ultra strong coupling ices in different states. In other words, it is possible to control the bistability of ultra strong coupling ice. Such bistability is expected to increase the industrial utility value of ultra strong coupling ice of light water (H₂O), as in the case of heavy water (D₂O) described in the following [Example 11].

In summary, ultra strong coupling ice of light water (H₂O) has three distinct features. First, ultra strong coupling ice has a large Rabi splitting energy: Ω_{R} that surpasses ultra strong coupling water. Secondly, a transition phenomenon of Rabi splitting energy: Ω_{R} accompanied by a change from double Rabi splitting to quadruple Rabi splitting, which has not been observed so far, appears. Third, the transition phenomenon is bistable. Therefore, ultra strong coupling ice of light water (H₂O), together with ultra strong coupling ice of heavy water (D₂O) described in the following [Example 11], occupies a special position among vibrational coupling materials, and various industrial uses can be expected in addition to promotion of chemical reactions.

### Example 11

In the example, comparison of relations between the Rabi splitting energy: Ω_{R} of OD stretching vibration and a concentration of water and ice of heavy water (D₂O) and the transition phenomenon of Rabi splitting energy: Ω_{R} of heavy water (D₂O) under ultra strong coupling will be described. The points of this example are as follows. First, as in the case of heavy water (D₂O) water under vibrational coupling, even in the case of heavy water (D₂O) ice under vibrational coupling, an exponential law (0.4 power law) similar to the square root law (0.5 power law) holds between Rabi splitting energy: Ω_{R} and number density: N. On the other hand, unlike heavy water (D₂O) water under vibrational coupling, in the case of heavy water (D₂O) ice under vibrational coupling, when the relative concentration is C/C₀=80% (C₀=40.6 mol·dm⁻³), the Rabi splitting energy is transited from Ω_{R}=527 cm⁻¹ to Ω_{R}=704 cm⁻¹. The experimental procedure is the same as in [Example 10].

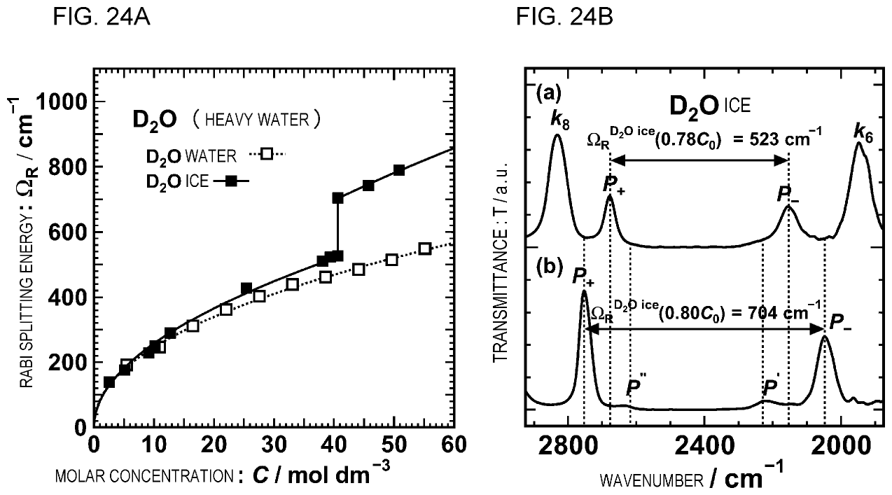

FIG. 24(A) illustrates a comparison of a relation between the Rabi splitting energy: Ω_{R} and concentration: C of OD stretching vibration of water and ice of heavy water (D₂O) under vibrational coupling. An open square indicates an experimental value plot for heavy water (D₂O) water, and a filled square indicates an experimental value plot for heavy water (D₂O) ice. The dotted line represents a fitting curve assuming an exponential function in the case of heavy water (D₂O) water, and the solid line represents a fitting curve assuming an exponential function in the case of heavy water (D₂O) ice. The same tendency as in the case of light water (H₂O) shown in [Example 10] is observed, and in the case of water and ice of heavy water (D₂O), while both follows the exponential law, ice under vibrational coupling, however, has a higher Rabi splitting energy: Ω_{R} than water under vibrational coupling at the same concentration. On the other hand, in the case of heavy water (D₂O) ice, the point that should be noted is that when the molar concentration is C=40.6 mol·dm⁻³ (relative concentration: C/C₀=80%), the Rabi splitting energy jumps sharply from Ω_{R}=527 cm⁻¹ to Ω_{R}=704 cm⁻¹ and moves from one exponential curve to another while satisfying the exponential law. Such a transition phenomenon is observed only in ultra strong coupling ice of light water (H₂O) shown in [Example 10] and ultra strong coupling ice of heavy water (D₂O) of this example. In the case of liquid heavy water (D₂O), the above-described quadruple splitting is not observed. This is presumably because that even with pure heavy water (D₂O), the coupling strength is Ω_{R}/ω₀≈0.22, and the coupling strength Ω_{R}/ω₀ does not reach the threshold for the transition phenomenon from double split to quadruple split.

FIG. 24(B) illustrates infrared transmission spectra of heavy water (D₂O) ice under ultra strong coupling before and after the transition. Specifically, (a) is a case where the relative concentration before the transition is C/C₀=78%, and (b) is a case where the relative concentration after the transition is C/C₀=80%. In the heavy water (D₂O) ice, the same tendency as in the case of the light water (H₂O) ice illustrated in [Example 10] is observed. Specifically, comparing (a) and (b), two distinct features are seen even with heavy water (D₂O) ice. The first feature is that the Rabi splitting energy: Ω_{R} changes greatly with a slight change in concentration, and the Rabi splitting energy actually increases greatly from Ω_{R}=523 cm⁻¹ to Ω_{R}=704 cm⁻¹. The second feature is that, similarly to the case of light water (H₂O) ice shown in [Example 10], the Rabi splitting is changed from double split (P₊ and P₋) to quadruple split (P₊, P″, P′, and P₋) before and after the transition.

In addition, one of the remarkable features of ultra strong coupling ice of heavy water (D₂O) is that as in the case of light water (H₂O) shown in [Example 10], a transition phenomenon from double split to quadruple split can occur in the vicinity of the transition concentration without changing the concentration. For example, at the same concentration in the vicinity of relative concentration: C/C₀=80%, ultra strong coupling ice with double split and relatively small Rabi splitting energy: Ω_{R}, or ultra strong coupling ice with quadruple split and relatively large Rabi split energy: Ω_{R} can be obtained separately, depending on the water-ice solidification and melting history. That is, by adjusting the concentration and the temperature, it is possible to make two ultra strong coupling ices in different states. In other words, it is possible to control the bistability of ultra strong coupling ice. Such bistability is expected to increase the industrial utility value of ultra strong coupling ice of heavy water (D₂O), as in the case of light water (H₂O) described in [Example 10].

In summary, ultra strong coupling ice of heavy water (D₂O) has three distinct features. First, ultra strong coupling ice has a large Rabi splitting energy: Ω_{R} that surpasses ultra strong coupling water. Secondly, a transition phenomenon of Rabi splitting energy: Ω_{R} accompanied by a change from double Rabi splitting to quadruple Rabi splitting, which has not been observed so far, appears. Third, the transition phenomenon is bistable. Therefore, ultra strong coupling ice of heavy water (D₂O), together with ultra strong coupling ice of light water (H₂O) described in [Example 10], occupies a special position among vibrational coupling materials, various industrial uses can be expected in addition to promotion of chemical reactions.

### Example 12

In this example, a relation between the coupling strength Ω_{R}/ω₀ related to OH (OD) stretching vibration and the concentration of ice of light water (H₂O) and heavy water (D₂O) will be described. The point of this example is that the transition concentration and transition width are slightly different between ultra strong coupling ice of light water (H₂O) and ultra strong coupling ice of heavy water (D₂O). The experimental procedure is the same as in [Example 10] and [Example 11].

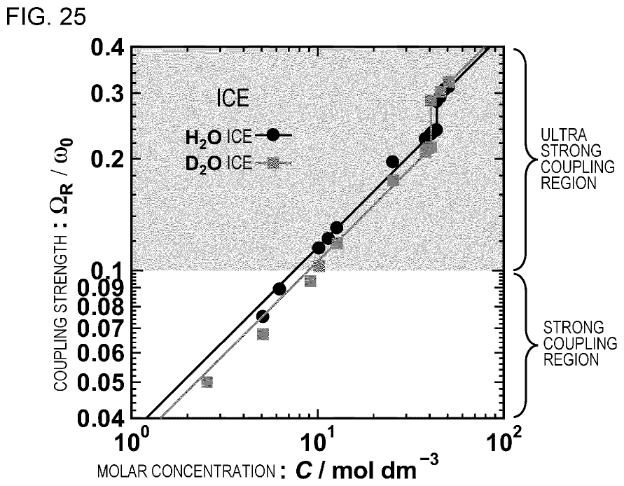

FIG. 25 is a diagram illustrating comparing a relation between a coupling strength Ω_{R}/ω₀ and concentrations of ice of light water (H₂O) and heavy water (D₂O). The vertical axis is the coupling strength: Ω_{R}/ω₀, the horizontal axis is the molar concentration: C, the black circle is an experimental value plot for light water (H₂O) ice, and the gray square is an experimental value plot for heavy water (D₂O) ice, the black solid line is a fitting curve assuming an exponential function for light water (H₂O) ice, and the gray solid line is a fitting curve assuming an exponential function for heavy water (D₂O) ice.

The features are listed below. First, in the case of light water (H₂O) ice and heavy water (D₂O) ice under vibrational coupling, the coupling strength Ω_{R}/ω₀ follows the exponential law for concentration. At a certain concentration, the coupling strength Ω_{R}/ω₀ of ice exhibits a transition phenomenon. In the case of ultra strong coupling ice of light water (H₂O), the transition concentration is a molar concentration: C=43.7 mol·dm⁻³ (relative concentration: C/C₀=86%), and the coupling strengths before and after the transition: Ω_{R}/ω₀ are respectively Ω_{R}/ω₀=0.24 and Ω_{R}/ω₀=0.29, the transition width is ΔΩ_{R}≈150 cm⁻¹ (about 18.6 meV) in terms of energy and Δ(Ω_{R}/ω₀)≈0.046 in terms of coupling strength: Ω_{R}/ω₀. In the case of ultra strong coupling ice of heavy water (D₂O), the transition concentration is a molar concentration: C=40.6 mol·dm⁻³ (relative concentration: C/C₀=80%), and the coupling strengths before and after the transition: Ω_{R}/ω₀ are respectively Ω_{R}/ω₀=0.22 and Ω_{R}/ω₀=0.29, the transition width is ΔΩ_{R}≈177 cm⁻¹ (about 22.0 meV) in terms of energy, and Δ(Ω_{R}/ω₀)≈0.072 in terms of coupling strength: Ω_{R}/ω₀. Therefore, the transition concentration is 6% higher in the relative concentration of the ultra strong coupling ice of light water (H₂O) than in the ultra strong coupling ice of heavy water (D₂O), and the transition width is ΔΩ_{R}≈22 cm⁻¹ (approximately 3.4 meV) larger in terms of energy in the ultra strong coupling ice of heavy water (D₂O) than in the ultra strong coupling ice of the light water (H₂O).

Other features include the following points. That is, in the case of light water (H₂O) water and heavy water (D₂O) water under vibrational coupling, the exponential curves thereof of the coupling strength: Ω_{R}/ω₀ with respect to the concentration almost coincide with each other, whereas in the case of light water (H₂O) ice and heavy water (D₂O) ice under vibrational coupling, there is a slight deviation between the exponential curves before and after the transition. Reflecting this deviation, there is also a difference in the transition from strong coupling to ultra strong coupling. In the case of light water (H₂O) ice, when the molar concentration: C being C≈7.3 mol·dm⁻³ (relative concentration: C/C₀≈14.3%) or more, an ultra strong coupling state is obtained, in the case of heavy water (D₂O), when the molar concentration C being: C≈8.9 mol·dm⁻³ (relative concentration: C/C₀≈17.5%) or more, an ultra strong coupling state is obtained. On the other hand, as described in [Example 1], in the case of light water (H₂O) water and heavy water (D₂O) water, the transition from the strong coupling state to the ultra strong coupling state occurs at the boundary of molar concentration: C≈9 mol·dm⁻³ (relative concentration: C/C₀≈16%).

To summarize the case of water and ice, as long as the vibrational coupling is in the category of double Rabi splitting, the transition from the strong coupling state to the ultra strong coupling state has the same level of relative concentration of water and ice C/C₀≈16±1.5% as the threshold value. On the other hand, in a case where the relative concentration is large, the light water (H₂O) ice and the heavy water (D₂O) ice have a particularly large coupling strength Ω_{R}/ω₀ because a transition phenomenon from double Rabi splitting to quadruple Rabi splitting is exhibited.

In summary, in the vibrational coupling of OH (OD) stretching vibration of water and ice, when the relative concentration is C/C₀≈16±1.5%, the strong coupling state is changed to the ultra strong coupling state. Moreover, it can be concluded that the reason why ultra strong coupling ice has a particularly large coupling strength: Ω_{R}/ω₀ after the transition concentration is derived from the quadruple Rabi splitting phenomenon.

### Example 13

In this example, how much chemical reaction is promoted when ultra strong coupling ice is used will be described. The point of this example is that it has become theoretically apparent that ultra strong coupling ice has an effect of promoting chemical reactions that surpasses ultra strong coupling water because the ultra strong coupling ice has a 50% increased coupling strength: Ω_{R}/ω₀ compared to the ultra strong coupling water.

In this example, based on (Expression 18), the relative reaction rate constants at 0° C. (273.15 K) were compared with those in the case of ultra strong coupling ice and ultra strong coupling water. In the numerical calculation, it was assumed that the coupling strength of ultra strong coupling ice is Ω_{R}/ω₀=0.333 and the coupling strength of ultra strong coupling water is Ω_{R}/ω₀=0.222.

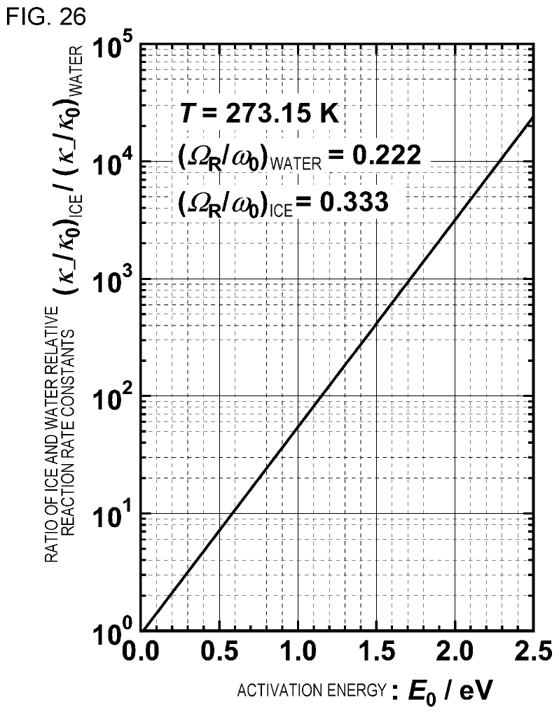

FIG. 26 illustrates activation energy dependence of a ratio of a relative reaction rate constant of ice (κ₋/κ₀)_{ice} to relative reaction rate constant of water (κ₋/κ₀)_{water} In the diagram, the most noteworthy feature is that the relative reaction rate constant of ice (κ₋/κ₀)_{ice} exceeds the relative reaction rate constant of water (κ₋/κ₀)_{water} regardless of the value of the activation energy E₀ of the original system, reflecting that the coupling strength Ω_{R}/ω₀ of ultra strong coupling ice is 1.5 times larger than that of ultra strong coupling water. For example, at the time of the activation energy is E₀=0.50 eV (48.2 kJ·mol⁻¹), the ratio of the relative reaction rate constant of ice to the relative reaction rate constant of water is (κ₋/κ₀)_{ice}/(κ₋/κ₀)_{water}≈7.14, at the time of E₀=1.00 eV (96.5 kJ·mol⁻¹), (κ₋/κ₀)_{ice}/(κ₋/κ₀)_{water}≈5.44×10, at the time of E₀=1.50 eV (145 kJ·mol⁻¹), (κ₋/κ₀)_{ice}/(κ₋/κ₀)_{water}≈4.15×10², at the time of E₀=2.00 eV (193 kJ·mol⁻¹), (κ₋/κ₀)_{ice}/(κ₋/κ₀)_{water}≈3.16×10³, and at the time of E₀=2.50 eV (241 kJ·mol⁻¹), (κ₋/κ₀)_{ice}/(κ₋/κ₀)_{water}≈2.40×10⁴. As shown above, the larger the activation energy E₀, the more the ratio of the relative reaction rate constant of ice to the relative reaction rate constant of water (κ₋/κ₀)_{ice}/(κ₋/κ₀)_{water} remarkably increases. In particular, when the activation energy is E₀>0.6 eV (57.9 kJ·mol⁻¹), the degree of reaction promotion is 10 times or more, and the ultra strong coupling ice promotes chemical reactions literally by orders of magnitude compared to ultra strong coupling water.

As discussed above, it is proven that the ultra strong coupling ice has a reaction promoting effect that surpasses the ultra strong coupling water. Examples of utilization methods in which ultra strong coupling ice is particularly effective include reaction in ice, reaction on ice, low temperature synthesis of biological substances that are easily denatured and chemical substances that are unstable at room temperature, chemical treatments in freshwater, seawater, and atmosphere where temperatures are below freezing, chemical decomposition of atmospheric pollutants, elimination of ozone holes, and chemical exploration in a cryogenic space environment.

### Example 14

In this example, a chemical reaction device used when ice under vibrational coupling is used for promoting a chemical reaction will be described. The point of this example is that even with ice, which is a solid, a chemical reaction process based on vibrational coupling can proceed sequentially as in the case of fluid.

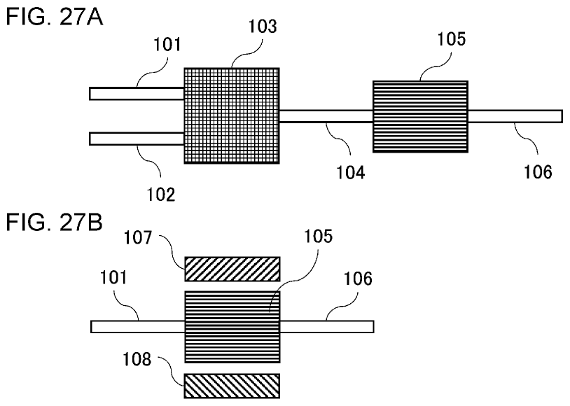

FIGS. 27(A) and 27(B) are schematic diagrams of a chemical reaction device when ice under a vibrational coupling is used for promoting a chemical reaction.

FIG. 27(A) is a device combining a device 103 for mixing liquid and ice and a vibrational coupling chemical reaction device 105, and the process is as follows. First, a liquid containing a reactant from a liquid inlet 101 and ice from an ice inlet 102 are introduced to the device 103 for mixing the liquid and ice. After the introduction, the liquid and water are mixed so finely using a method such as pulverization, stirring, and ultrasonic vibration that those can move in the capillary tube of the vibrational coupling chemical reaction device 105 as a fluid. Next, the fluid in which the liquid and ice are mixed is introduced to the vibrational coupling chemical reaction device 105 through the channel 104. Finally, a chemical reaction is performed by applying a vibrational coupling to the mixed fluid in the vibrational coupling chemical reaction device 105, and the fluid containing the product is discharged from the outlet 106.

FIG. 27(B) is a device combining a cooling device 107, a heating device 108, and a vibrational coupling chemical reaction device 105, and the process is as follows. First, a liquid containing a reactant and water is introduced from the inlet 101 to the vibrational coupling chemical reaction device 105. Next, by using the cooling device, the liquid containing the reactant and water introduced into the vibrational coupling chemical reaction device 105 is frozen to generate ice under vibrational coupling, and the reactant is chemically reacted with the ice. After completion of the chemical reaction, the frozen body containing the product is thawed and returned to the liquid using the heating device 108. Finally, the liquid containing the product is discharged from the outlet 106.

Both devices in FIGS. 27(A) and 27(B) allow to handle ice under vibrational coupling as well as solvent under vibrational coupling with only few processes or addition of equipment.

As shown above, even with ice under vibration coupling, it is possible to sequentially proceed with a chemical reaction process based on vibrational coupling without sacrificing convenience by imparting fluidity by mixing with liquid, or by using phase change between water and ice.

### Example 15

In this example, a rise in the melting point of ice composed of light water (H₂O) and heavy water (D₂O), in which the OH stretching vibration and the OD stretching vibration are vibrationally coupled simultaneously, will be described. The point of this example is that a phenomenon has been found in which the melting point of ice under vibrational coupling rises by approximately 0.2° C. compared to normal ice. Although this melting point rise is approximately 0.2° C. and the value itself is small, it is the first case of observing physical property conversion by vibrational coupling other than chemical reactivity.

The experimental procedure is the same as in [Example 12]. Melting points were measured at various concentrations for a mixture of light water (H₂O) and heavy water (D₂O). Ultra strong coupling ice and normal ice were formed using the same measuring device except for the presence or absence of a metal mirror, that is, the presence or absence of cavity. In the case of ultra strong coupling ice, the cavity length was adjusted so that the vibrational modes of OH stretching and OD stretching could be vibrationally coupled simultaneously with the cavity. Regarding temperature control, cooling was performed with a refrigerant from a thermostatic chamber, and heating was performed with natural heat radiation to the atmosphere. Melting point measurement was performed using a thermocouple, and in order to measure melting point correctly, the temperature rise in the vicinity of melting point was performed taking a sufficient time of about 0.1° C./min. The phase change between water and ice was performed by observing changes in the infrared transmission spectrum in real time.

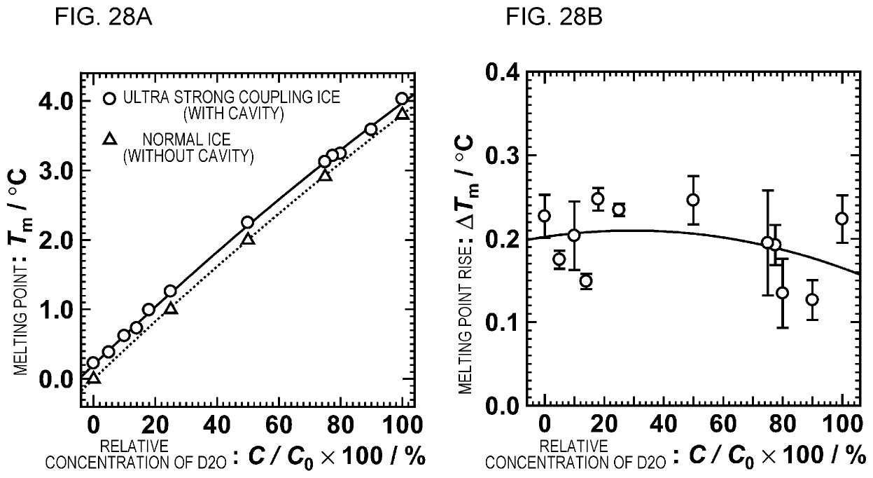

FIG. 28(A) is a diagram comparing melting points of ultra strong coupling ice and normal ice. The vertical axis represents the melting point: Tₙ, (° C.), and the horizontal axis represents the percentage of the relative concentration of D₂O: C/C₀×100(%). In general, it is known that the melting point of ice in light water (H₂O) is Tₘ=0.00° C., the melting point of ice in heavy water (D₂O) is Tₘ=3.82° C. The melting point of ice in the mixture of both is represented by (Expression 27), which is a quadratic function of the relative concentration C/C₀ of D₂O.

$${T}_{m} = 4.212 \times \frac{C}{{C}_{0}} - 0.408 \times {( \frac{C}{{C}_{0}} )}^{2} \qquad ( Expression 27 )$$

In FIG. 28(A), an open triangle shows an average value of the experimental plots of normal ice, and an open circle shows an average value of the experimental plots of ultra strong coupling ice. The dotted line is the theoretical curve of normal ice based on (Expression 27), and the solid line is the experimental curve when fitting the experimental values of ultra strong coupling ice with a quadratic expression. As is apparent from FIG. 28(A), the melting point of ultra strong coupling ice is significantly higher than that of normal ice at any relative concentration of 0 to 100%. FIG. 28(B) shows the relative concentration dependence of the melting point rise ΔTₘ(° C.) obtained by subtracting the melting point of normal ice from the melting point of ultra strong coupling ice. An open circle is an average value of experimental plots, an error bar is a standard error, and a solid line is an experimental curve fitted with a quadratic expression. As is apparent from FIG. 28(B), it is confirmed that the melting point rise from normal ice to ultra strong coupling ice is about 0.2° C. on average. This melting point rise in ultra strong coupling ice is an example of physical property conversion by vibrational coupling, which was first confirmed except for chemical reactivity.

As discussed above, by showing the example of the melting point rise of ultra strong coupling ice, it was shown that the fundamental property of the substance can be changed by vibrational coupling.

Although example embodiment of this invention was described above with reference to drawings, these are merely examples of the present invention, and various configurations other than those described above can be employed.

1. An object comprising:
a matter having at least one of an OH group and an OD group,
wherein the object exists in a structure in which light having a wavelength that resonates with stretching vibration of the at least one group resonates.

2. The object according to claim 1,
wherein the matter is a fluid.

3. The object according to claim 1,
wherein the matter is water.

4. The object according to claim 1,
wherein the matter is ice.

5. The object according to claim 1,
wherein the matter is a mixture of water and ice.

6. The object according to claim 3,
wherein the matter is in a vibrational ultra strong coupling state.

7. The object according to claim 1,
wherein the matter is a solvent,
the object further comprising a solute.

8. A device comprising:
a structure in which light having a wavelength that resonates with stretching vibration of at least one of an OH group and an OD group resonates; and
an inlet for introducing an object into the structure.

9. The device according to claim 8, further comprising:
an outlet for discharging at least one of the object placed in the structure and a product generated by a reaction of at least a part of the object.

10. The device according to claim 8,
wherein the structure is a Fabry-Pérot cavity or a plasmon-polariton structure.

11. The device according to claim 8,
wherein the object is water, ice, or a mixture of water and ice.

12. The device according to claim 11,
wherein the device brings the water, ice, or mixture of water and ice into a vibrational ultra strong coupling state.

13. A processing method comprising:
placing a solvent containing a solute inside a structure in which light having a wavelength that resonates with stretching vibration of a group included in the solvent resonates; and
reacting the solute.

14. The processing method according to claim 13,
wherein the solvent is brought into a vibrational ultra strong coupling state when the solute is reacted.

15. The processing method according to claim 13,
wherein the group is at least one of an OH group and an OD group.

16. The processing method according to claim 15,
wherein the solute includes water, ice, or a mixture of water and ice.
